(19) United States
(12) Patent Application Publication
(10) Pub. No.: US 2019/0392505 A1
(43) Pub. Date: Dec. 26, 2019

(54) ITEM INFORMATION ACQUISITION SYSTEM, SHOPPING ASSISTANCE SYSTEM, SHOPPING ASSISTANCE METHOD, AND CARRIER

(71) Applicant: Panasonic Intellectual Property Management Co., Ltd., Osaka (JP)

(72) Inventor: Tatsuaki AMEMURA, Tokyo (JP)

(21) Appl. No.: 16/443,967

(22) Filed: Jun. 18, 2019

(30) Foreign Application Priority Data
Jun. 20, 2018 (JP) 2018-117409
Aug. 2, 2018 (JP) 2018-146320

(51) Int. Cl. G06Q 30/06; G06K 9/03; G06K 9/00

(52) U.S. Cl. CPC G06Q 30/0633; G06K 2209/17; G06K 9/00624; G06K 9/03

(57) ABSTRACT

An item information acquisition system includes a carrier and an acquirer. The carrier includes a placement section, a projection, and an image capturing section. The placement section includes a placement surface on which an item as a carriage target is to be placed. The projection protrudes from the placement section in a direction transverse to the placement surface. The image capturing section is held by the projection and has an image capturing range corresponding to at least the placement surface. The image capturing section is disposed spaced away from an entire perimeter of a peripheral edge of the placement section when viewed in a direction orthogonal to the placement surface. The acquirer is configured to identify, based on the image captured by the image capturing section, the item placed on the placement surface and acquiring item information on the item.

### CROSS-REFERENCE TO RELATED APPLICATION

The present application is based upon and claims the benefit of priority of Japanese Patent Application No. 2018-117409, filed on Jun. 20, 2018 and Japanese Patent Application No. 2018-146320, filed on Aug. 2, 2018, the entire contents of which are incorporated herein by reference.

### TECHNICAL FIELD

The present disclosure generally relates to item information acquisition systems, shopping assistance systems, shopping assistance methods, and carriers. Specifically, the present disclosure relates to an item information acquisition system, a shopping assistance system, a shopping assistance method, and a carrier for acquiring information on an item placed on a placement surface of the carrier.

### BACKGROUND ART

Document 1 (JP2016-57813A) describes a goods management system configured to perform identification of goods in a shopping basket. In the goods management system, the shopping basket includes a communication device configured to perform wireless communication with a server. The communication device includes an image capturing section configured to capture a moving image in the shopping basket and a wireless communication section configured to transmit the moving image captured by the image capturing section to the server. The server includes an object recognizer configured to track, based on the moving image, locations of the goods put in the shopping basket, and an image recognizer configured to perform, based on the moving image, image recognition of the goods to identify the goods. The object recognizer continues tracking the locations of the goods until the goods are identified by the image recognizer.

In the goods management system (item information acquisition system) described in Document 1, the image capturing section is disposed at a location at which capturing an entire image of the interior of the shopping basket (carrier) is difficult. Thus, on a placement surface on which goods (items) are to be placed, a blind spot is more likely to occur in the image capturing range of the image capturing section, and therefore, it is difficult to identify the items based on an image capturing result by the image capturing section.

### SUMMARY

The present disclosure relates to an item information acquisition system, a shopping assistance system, a shopping assistance method, and a carrier which easily identify an item based on an image capturing result by an image capturing section.

An item information acquisition system of one aspect of the present disclosure includes a carrier and an acquirer. The carrier includes a placement section, a projection, and an image capturing section. The placement section includes a placement surface on which an item as a carriage target is to be placed. The projection protrudes from the placement section in a direction transverse to the placement surface. The image capturing section is held by the projection and has an image capturing range corresponding to at least the placement surface. The image capturing section is disposed spaced away from an entire perimeter of a peripheral edge of the placement section when viewed in a direction orthogonal to the placement surface. The acquirer is configured to identify, based on an image captured by the image capturing section, the item placed on the placement surface and acquire item information on the item.

A shopping assistance system of one aspect of the present disclosure includes the above-described item information acquisition system, and a sales system. The sales system is a system for performing a sales process of the item placed on the placement surface.

A shopping assistance method of one aspect of the present disclosure is a shopping assistance method which adopts a carrier. The carrier includes a placement section, a projection, and an image capturing section. The placement section includes a placement surface on which an item as a carriage target is to be placed. The projection protrudes from the placement section in a direction transverse to the placement surface. The image capturing section is held by the projection and has an image capturing range corresponding to at least the placement surface. The image capturing section is disposed spaced away from an entire perimeter of a peripheral edge of the placement section when viewed in a direction orthogonal to the placement surface. The shopping assistance method includes capturing an image of the placement surface on which the item is placed by the image capturing section. The shopping assistance method further includes identifying, based on an image captured by the image capturing section, the item placed on the placement surface and acquire item information on the item. Moreover, the shopping assistance method includes performing, based on the item information, a sales process of the item placed on the placement surface.

A carrier according to one aspect of the present disclosure is adopted in the above-described item information acquisition system.

### BRIEF DESCRIPTION OF THE DRAWINGS

FIG. 1 is a sectional view illustrating a shopping basket which is adopted in an item information system according to a first embodiment of the present disclosure, wherein goods are in the shopping basket;

FIG. 2A is an exterior perspective view of the shopping basket;

FIG. 2B is an exterior perspective view of the shopping basket;

FIG. 3 is a top view illustrating the shopping basket;

FIG. 4 is a block diagram schematically illustrating a configuration of an item information acquisition system and a shopping assistance system of the first embodiment;

FIG. 5 is an exterior perspective view illustrating a counter desk to which the shopping assistance system is applied, wherein part of the counter desk is omitted;

FIG. 6A is a view illustrating an example of a method for acquiring a difference image in the item information acquisition system;

FIG. 6B is a view illustrating the example of the method for acquiring the difference image in the item information acquisition system;

FIG. 6C is a view illustrating the example of the method for acquiring the difference image in the item information acquisition system;

FIG. 7 is a flowchart illustrating operation of the item information acquisition system;

FIG. 8A is an exterior perspective view illustrating a terminal adopted in an item information acquisition system according to a first variation of the first embodiment of the present disclosure;

FIG. 8B is a view illustrating an example of a method for attaching the terminal to the shopping basket in the item information acquisition system of the first variation;

FIG. 8C is a view illustrating the terminal attached to the shopping basket in the item information acquisition system of the first variation;

FIG. 9 is an exterior perspective view illustrating a shopping basket and a terminal in an item information acquisition system according to a second variation of the first embodiment of the present disclosure;

FIG. 10A is an exterior view illustrating a shopping basket in an item information acquisition system according to a third variation of the first embodiment of the present disclosure;

FIG. 10B is an exterior view illustrating the shopping basket in the item information acquisition system of the third variation.

FIG. 10C is an exterior view illustrating the shopping basket in the item information acquisition system of the third variation;

FIG. 11 is an exterior perspective view illustrating a cart in an item information acquisition system according to a fourth variation of the first embodiment of the present disclosure;

FIG. 12 is a block diagram schematically illustrating a configuration of an item identification system and a shopping assistance system according to a second embodiment of the present disclosure;

FIG. 13 is a block diagram schematically illustrating a configuration of an identification section in the item identification system;

FIG. 14 is a flowchart illustrating operation of the item identification system in an inference phase;

FIG. 15A is a block diagram schematically illustrating a configuration of a shopping basket in an item identification system according to a first variation of the second embodiment of the present disclosure;

FIG. 15B is a block diagram schematically illustrating a configuration of a shopping basket in an item identification system according to a second variation of the second embodiment of the present disclosure;

FIG. 16 is a block diagram schematically illustrating a configuration of a sales system in an item identification system and a shopping assistance system according to a third variation of the second of the present disclosure; and

FIG. 17 is a block diagram schematically illustrating a configuration of an identification section in an item identification system according to a fourth variation of the second embodiment of the present disclosure.

### DETAILED DESCRIPTION

### First Embodiment

### (1) Schema

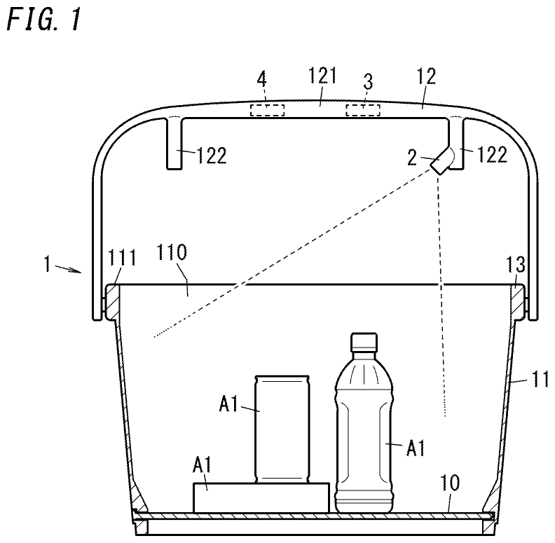

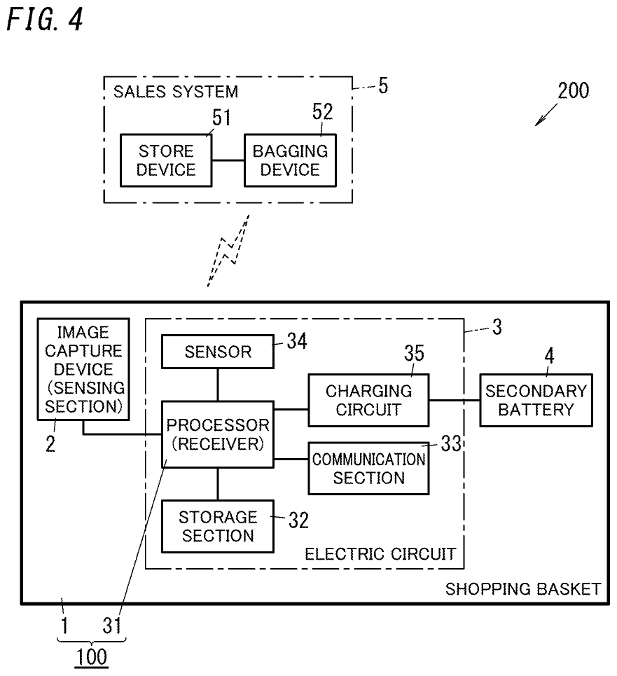

First, a schema of an item information acquisition system 100 of the present embodiment will be described with reference to FIGS. 1 and 4. The item information acquisition system 100 of the present embodiment is a system configured to acquire respective pieces of item information on one or more items A1 placed on a placement surface 10 (see FIG. 1) of a carrier 1. In other words, the carrier 1 is used in the item information acquisition system 100. As used herein, the term “carrier” refers to an apparatus which allows at least one item A1 to be carried, that is, “carried from one place to another” in, for example, a facility such as a store and allows the one or more items A1 to be moved together with the carrier 1 holding the one or more items A1. Specifically, the carrier 1 is, for example, a container such as a basket or a tableware which accommodates one or more items A1 to hold the one or more items A1, or a cart, a tray, a dish, a hand truck, or the like which supports one or more items A1 thereon to hold the one or more items A1. Moreover, as used herein, the term “item information” refers to information for identifying an item A1. For example, when items A1 are goods, the item information is goods information (goods identification code) and is, for example, Japanese Article Number (JAN) code or the like used in Japan. Moreover, the item information is not limited to the information identifying the product type (kind) of each of the items A1 but may include information such as serial information individually identifying items A1 of an identical product type. Thus, in the case of items A1 of an identical product type, the items A1 of the identical product type are individually identifiable based on their pieces of item information.

In the present embodiment, an example in which the carrier 1 is a shopping basket will be described. In the following description, the carrier 1 is also referred to as a “shopping basket 1” unless otherwise indicated. The shopping basket 1 is used in, for example, a convenience store, a supermarket, a department store, a drugstore, an electronics retail store, and a retail store such as a home center (hardware store). The shopping basket 1 is used to carry goods as the items A1 sold in such a store. In the following description, the items 1A are also referred to as “goods A1” unless otherwise indicated. Moreover, in the following description, item information on each of the goods A1 is referred to as “goods information” unless otherwise indicated.

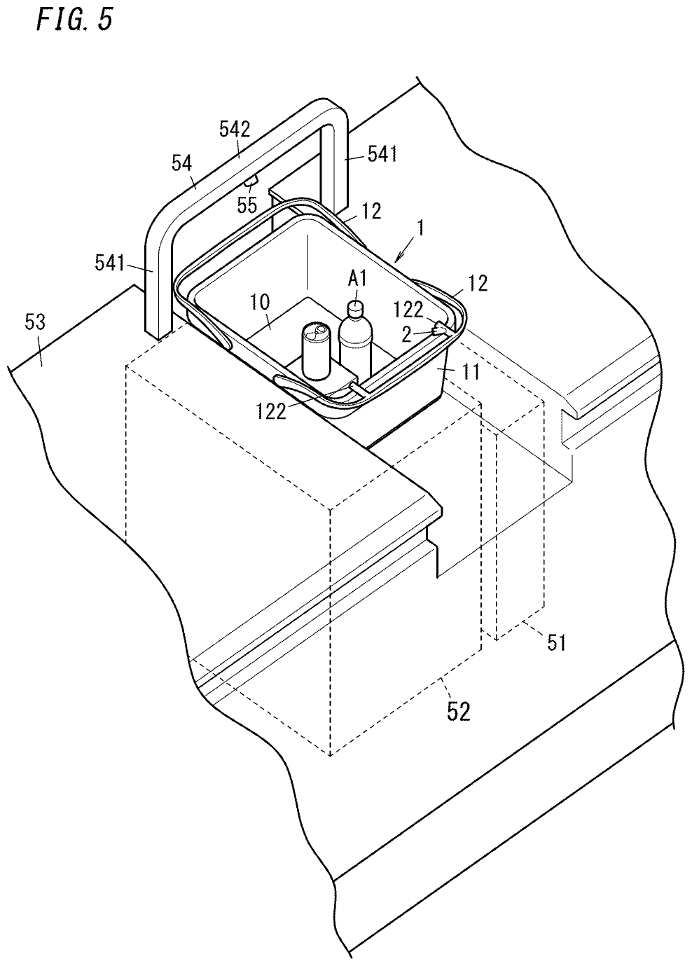

The item information acquisition system 100 is assumed to be introduced in a store together with a sales system 5 and to form a shopping assistance system 200 to assist a customer in shopping. The sales system 5 is a system configured to perform a sales process of one or more items A1 as goods. In the present embodiment, the sales system 5 includes a store device 51. The store device 51 is installed in, for example, a counter desk 53 (see FIG. 5) in the store and has a function such as checkout processing. When placed on the counter desk 53, the shopping basket 1 transmits, to the store device 51, respective pieces of goods information on the one or more goods A1 accommodated in the shopping basket 1 by using a communication section 33 (see FIG. 4) which will be described later. Thus, in the store device 51, a checkout process of the one or more goods A1 becomes possible based on the respective pieces of goods information received from the shopping basket 1.

A store which the shopping basket 1 is introduced into enables a customer (user) to finish purchasing one or more goods A1 by a series of actions of picking up the one or more goods A1 in the store, putting them in the shopping basket 1, and performing checkout thereof with the store device 51. Thus, in stores which the shopping basket 1 is introduced into, it is possible to reduce, for example, a time from the start of the checkout process to reception of the one or more goods A1 by the customer while saving the labor of employees (clerks) in the stores and labor of the customer, thereby reducing a time which the customer takes for shopping.

Here, the item information acquisition system 100 of the present embodiment adopts the following configuration to acquire respective pieces of goods information (item information) on one or more goods (items) A1 accommodated in the shopping basket (carrier) 1. That is, the item information acquisition system 100 includes the shopping basket 1 and an acquirer 31.

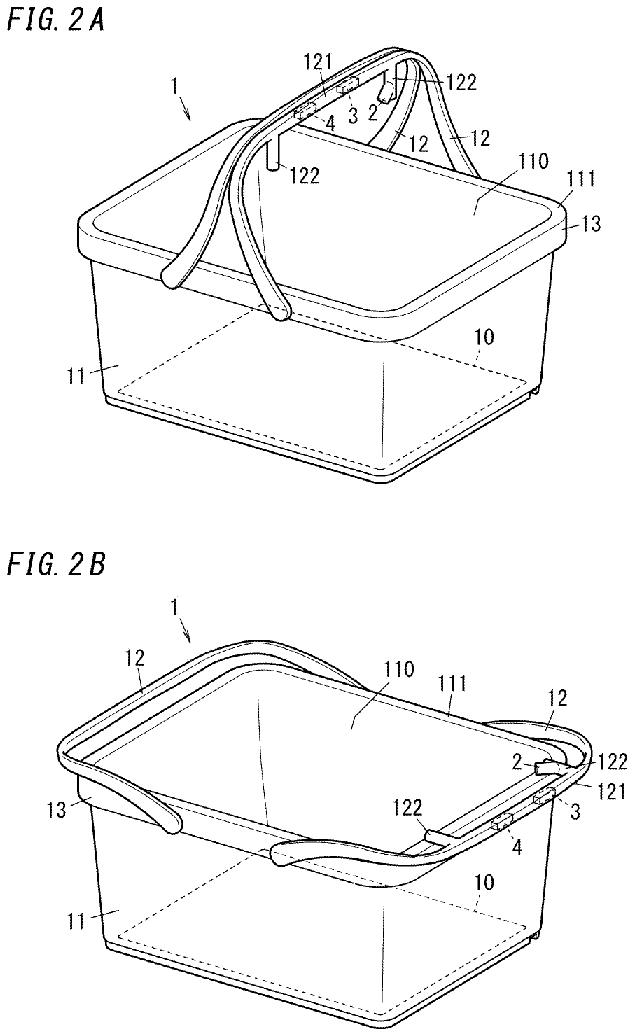

The shopping basket 1 includes a placement section 11, a projection 12, and an image capturing section 2. The placement section 11 is a body of the shopping basket 1 and includes the placement surface 10 on which one or more goods A1 as carriage targets are to be placed. In the following description, the placement section 11 is also referred to as a “body 11” unless otherwise indicated. The projection 12 is one of a pair of grips 12 provided to the body 11 and protrudes from the body (placement section) 11 in a direction transverse to the placement surface 10. Here, the direction transverse to the placement surface 10 is the upward direction in FIG. 2A, that is, a direction from the placement surface 10 toward an opening section 110 in the body 11. Moreover, in the following description, the projection 12 is also referred to as a “grip 12” unless otherwise indicated. The image capturing section 2 is held by one grip 12 of the pair of grips 12 and has an image capturing range corresponding to at least the placement surface 10. That is, the image capturing section 2 is configured to capture respective images of one or more goods A1 accommodated in the body 11, in other words, the one or more goods A1 placed on the placement surface 10, or one or more goods A1 mounted on the one or more goods A1 placed on the placement surface 10.

The acquirer 31 is a processor included in the shopping basket 1. The acquirer 31 is configured to identify, based on the image captured by the image capturing section 2, each of the one or more goods (items) A1 placed on the placement surface 10 and acquire respective pieces of goods information (item information) on the one or more goods A1 identified. That is, the acquirer 31 accordingly processes an image including the one or more goods A1 imaged by the image capturing section 2 to identify each of the one or more goods A1 and acquires respective pieces of goods information on the one or more goods A1. In the following description, the acquirer 31 is also referred to as a “processor 31” unless otherwise indicated.

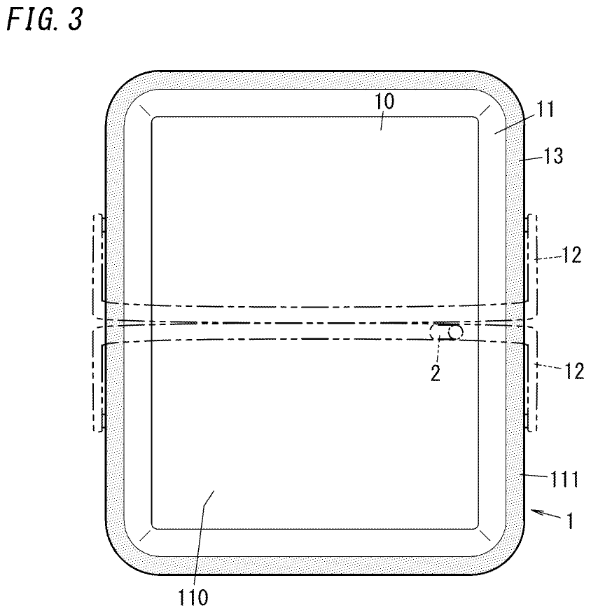

In the present embodiment, the image capturing section 2 is disposed spaced away from an entire perimeter of a peripheral edge 111 (hatched section in FIG. FIG. 3) of the body (placement section) 11 (see FIG. 3) when viewed in a direction orthogonal to the placement surface 10. Here, the direction orthogonal to the placement surface 10 is the up-and-down direction in FIG. 2A, that is, a direction in which the placement surface 10 and the opening section 110 of the body 11 are aligned. Note that hatching in FIG. 3 is used merely to emphasize the peripheral edge 111 of the body 11 and has no entity.

As described above, in the present embodiment, when viewed in the direction orthogonal to the placement surface 10, the image capturing section 2 is located on an inner side of the placement surface 10 but not at the peripheral edge 111 of the body (placement section) 11. Thus, in the present embodiment, on the placement surface 10 on which one or more goods (items) A1 are to be placed, a blind spot does not tend to occur in the image capturing range of the image capturing section 2, and identification of each of the one or more goods A1 based on an image capturing result by the image capturing section 2 is easy.

### (2) Details

A configuration of the item information acquisition system 100 according to the present embodiment will be explained in detail below. As illustrated in FIG. 4, the item information acquisition system 100 of the present embodiment includes the shopping basket 1 and the processor 31. In the present embodiment, the processor 31 is one of components included in the shopping basket 1. In the present embodiment, a shopping basket 1 used in a convenience store will be described as an example of the carrier 1. Moreover, in the present embodiment, goods A1 handled in the convenience store will be described as an example of the items A1.

### (2.1) Shopping Assistance System

First, an overall structure of the shopping assistance system 200 including the shopping basket 1 according to the present embodiment will be described with reference to FIG. 4. The shopping assistance system 200 includes the item information acquisition system 100 and the sales system 5 including the store device 51. Moreover, the sales system 5 further includes a bagging device 52.

In the present embodiment, the store device 51 is installed in the counter desk 53 of the store (convenience store) (see FIG. 5). The counter desk 53 is a desk on which the shopping basket (carrier) 1 is to be disposed so that a sales process is performed by the sales system 5. The store device 51 has a communication function with the shopping basket 1. When the shopping basket 1 is placed in a checkout space of the counter desk 53, the store device 51 communicates with the shopping basket 1 so as to acquire goods information from the shopping basket 1.

In this embodiment, when a customer picks up an item of goods A1 in the store and puts it in the shopping basket 1, the shopping basket 1 acquires goods information on the item of goods A1. The shopping basket 1 then stores the goods information thus acquired on the item of goods A1 in a storage section 32 which will be described later (see FIG. 4). Thus, when one or more goods A1 are put in the shopping basket 1, respective pieces of goods information on the one or more goods A1 are stored in the storage section 32 of the shopping basket 1. When placed in the checkout space of the counter desk 53, the shopping basket 1 transmits the respective pieces of goods information on the one or more goods A1 stored in the storage section 32 to the store device 51 by using the communication section 33.

The store device 51 thus acquires goods information transmitted from the shopping basket 1, thereby acquiring the respective pieces of goods information on the one or more goods A1 put in the shopping basket 1. Based on the respective pieces of goods information acquired from the shopping basket 1, the store device 51 executes the checkout process of the one or more goods A1. Thus, in stores which the shopping basket 1 is introduced into, it is possible to reduce, for example, a time from the start of the checkout process to reception of the one or more goods A1 by the customer while saving the labor of employees (clerks) in the stores and labor of the customer, thereby reducing a time which the customer takes for shopping.

The bagging device 52 is a device configured to perform bagging of moving the one or more goods A1 from the shopping basket 1 into a takeout container. Examples of the takeout container include a bag, a basket, a box, a cart, and a sack. In the present embodiment, as an example, the takeout container is assumed to be a shopping bag (a so-called plastic shopping bag) made of polyethylene or polypropylene. That is, the one or more goods after completion of the checkout process thereof are to be moved from the shopping basket 1 to a takeout container (in this embodiment, a shopping bag) so as to be taken home by the customer. This requires a bagging action of moving the one or more goods A1 from the shopping basket 1 into the shopping bag. In the present embodiment, the bagging action is automatically performed by the bagging device 52 and thus, does not have to be performed by clerks or the customer.

The bagging device 52 is, for example, built in the counter desk 53. The bagging device 52 includes, for example, a mechanism configured to open and close a bottom panel of the body 11 of the shopping basket 1. When the shopping basket 1 is placed in the checkout space of the counter desk 53, the bagging device 52 opens the bottom panel of the body 11 of the shopping basket 1 to discharge each of the one or more goods A1 through the bottom of the body 11 of the shopping basket 1. When each of the one or more goods A1 are discharged through the bottom of the shopping basket 1, the bagging device 52 bags each of the one or more goods A1 into the shopping bag at the counter desk 53. Thus, in a state where the shopping basket 1 is placed in the checkout space of the counter desk 53, bagging of the one or more goods A1 is completed at the counter desk 53. Thereafter, in a state where the shopping basket 1 is removed from the checkout space, the bagging device 52 discharges the one or more goods A1 being in a bagged state, that is, being accommodated in a shopping bag into the checkout space of the counter desk 53. Thus, the customer can bring back the one or more goods A1 which are placed on the counter desk 53 and which are in a bagged state.

The bagging device 52 communicates with the store device 51 to be interlocked with the store device 51. That is, the bagging device 52 has a communication function with the store device 51. In the present embodiment, when the shopping basket 1 is placed in a checkout space, the shopping assistance system 200 first communicates with the shopping basket 1 via the store device 51 to acquire the respective pieces of goods information from the shopping basket 1 by the store device 51. After the acquisition of the respective pieces of goods information is completed, the store device 51 transmits a bagging start signal to the bagging device 52. When receiving the bagging start signal from the store device 51, the bagging device 52 starts bagging each of the one or more goods A1. Then, when the checkout process by the store device 51 is completed, and the shopping basket 1 is removed from the checkout space, the store device 51 transmits a discharge start signal to the bagging device 52. When receiving the discharge start signal from the store device 51, the bagging device 52 discharges each of the one or more goods A1 in a bagged state into the checkout space.

According to the shopping assistance system 200, placing the shopping basket 1 in the checkout space of the counter desk 53 starts the bagging of each of the one or more goods A1, and while the customer performs the checkout process, the bagging of each of the one or more goods A1 is completed, and after the completion of the checkout process, each of the one or more goods A1 can be received by the customer. Thus, no intervention by the customer and clerks has to be involved in processes after the customer places the shopping basket 1 in a checkout space of the counter desk 53 until the customer receives each of the one or more goods A1 in the bagged state except for the checkout process. Thus, as compared to conventional shopping during which operations such as reading of the goods information and bagging are performed by the customer or clerks, the labor of the customer and the labor of the clerks are reduced.

In the shopping assistance system 200 according to the present embodiment, retrieval (removal) of the shopping basket 1 from the checkout space is basically performed by the customer himself/herself. Specifically, when the discharging of each of the one or more goods A1 from the shopping basket 1 is completed, the bagging device 52 closes the bottom panel of the shopping basket 1. Thereafter, for example, the store device 51 performs notification to prompt the retrieval of the shopping basket 1 by means of display, voice, or the like. When receiving the notification, the customer moves the shopping basket 1 which is empty and which is placed in the checkout space to the basket area. In each basket area, a power supply apparatus is provided. When the shopping basket 1 is returned to the basket area, the power supply apparatus is stacked with the shopping basket 1.

In this embodiment, the shopping basket 1 includes a secondary battery (battery) 4 as illustrated in FIG. 4. The secondary battery 4 serves as a power supply for operation of the image capturing section 2 and operation of the electric circuit 3 including the processor 31 and like. The secondary battery 4 is, for example, a lithium ion battery. The secondary battery 4 supplies electric power to the image capturing section 2 and the electric circuit 3 to operate the image capturing section 2 and the electric circuit 3. That is, the secondary battery 4 supplies electric power for the operation of the shopping basket 1 (the image capturing section 2 and the electric circuit 3) during use of the shopping basket 1. Therefore, after the use of the shopping basket 1, (the secondary battery 4 of) the shopping basket 1 has to be charged. Thus, in the present embodiment, the power supply apparatus charges the shopping basket 1 placed in the basket area.

In the present embodiment, the power supply apparatus charges the plurality of shopping baskets 1 in a state where the plurality of shopping baskets 1 are stacked in a row (stacked state) in the basket area. That is, in the present embodiment, one power supply apparatus placed in the basket area charges the plurality of shopping baskets 1 stacked in the vertical direction (gravity direction). Each shopping basket 1 receives electric power from the power supply apparatus and charges the secondary battery 4 by using a charging circuit 35.

### (2.2) Shopping Basket

Next, a configuration of the shopping basket 1 will be described with reference to FIGS. 1 to 4. The shopping basket 1 includes the body 11, the image capturing section 2, the electric circuit 3, and the secondary battery 4. In the present embodiment, the image capturing section 2, the electric circuit 3, and the secondary battery 4 are accommodated in one grip 12 of the pair of grips 12 and are electrically connected to each other. In FIG. 4, a circuit configuration of the shopping basket 1 is shown, and the body 11 is omitted.

The body 11 is in a shape of a box that has at least an opening at the top. The body 11 includes the pair of grips 12 and a flange 13 disposed around the opening section 110. An upper surface of the bottom panel of the body 11 is the placement surface 10 on which a plurality of goods A1 are to be placed. Thus, the body 11 allows a plurality of goods A1 to be put in. The flange 13 is continuous at an upper edge of the body 11 and has a frame shape surrounding the opening section 110 of the body 11.

Each of the pair of grips 12 is foldable and has a base portion supported by the flange 13. That is, the pair of grips 12 is provided to the body (placement section) 11. The pair of grips 12 is a portion gripped by a customer when the customer carries (support and move) the shopping basket (carrier) 1. In the present embodiment, each of the pair of grips 12 is configured to pivot with its base portion as an axis to be movable between a first location shown in FIG. 2A and a second location shown in FIG. 2B.

In the first location, each of the pair of grips 12 is upright such that the handle portion of each of the pair of grips 12 is located above the opening section 110. Thus, when the pair of grips 12 is in the first location, it is possible for a customer to grip the pair of grips 12 to carry the shopping basket 1. That is, the first location is a location in a case where the shopping basket (carrier) 1 is carried, in other words, in a case where the shopping basket 1 is in a used state.

In the second location, each handle portion of the pair of grips 12 is folded to a location close to the flange 13. Thus, when the pair of grips 12 is in the second location, it is not possible for the customer to grip the pair of grips 12 to carry the shopping basket 1. That is, the second location is a location in a case where the shopping basket (carrier) 1 is not carried, in other words, in a case where the shopping basket 1 is not in the used state.

In a state where the shopping basket 1 is stacked in the basket area, the pair of grips 12 is in the second location. When a customer takes the shopping basket 1 out of the basket area, the pair of grips 12 is moved by a hand of the customer from the second location to the first location.

The image capturing section 2 includes a solid-state imaging element such as a charge-coupled device (CCD) image sensor. The image capturing section 2 captures an image of the interior of the shopping basket 1, thereby obtaining an image of one or more goods A1 accommodated in the shopping basket 1. That is, the image capturing section 2 has an image capturing range corresponding to at least the placement surface 10. The image captured by the image capturing section 2 is transmitted to the processor 31.

As illustrated in FIGS. 2A and 2B, a pair of projections 122 protrudes from a handle portion 121 of one grip 12 of the pair of grips 12 in a lengthwise direction of the handle portion 121 with a space therebetween. When the pair of grips 12 is in the first location, the pair of projections 122 protrudes downward in FIG. 2A (that is, in a direction toward the placement surface 10 from the opening section 110. The image capturing section 2 is provided to a lower end of one projection 122 of the pair of projections 122. Thus, when a customer grips the handle portions 121 to carry the shopping basket 1, a hand of the customer is less likely to enter the image capturing range of the image capturing section 2.

In the present embodiment, when the pair of grips 12 is in the first location, the image capturing section 2 is in the location shown in FIG. 3. Specifically, when shopping basket 1 is viewed from the upper side in FIG. 2A, in other words, viewed in a direction orthogonal to the placement surface 10, the image capturing section 2 is located on an inner side of the four sides of the placement surface 10. That is, in the present embodiment, when the shopping basket 1 is viewed from the upper side in FIG. 2A, the image capturing section 2 captures an image of the placement surface 10 from a location with a distance to the four sides of the flange 13, in other words, with a distance to the entire perimeter of the peripheral edge 111 of the body (placement section) 11.

In the present embodiment, the image capturing section 2 functions also as a sensing section configured to sense placing of an item of goods (item) A1 on the placement surface 10. That is, when an item of goods A1 is placed on the placement surface 10, the item of goods A1 enters the image capturing range of the image capturing section 2. Thus, when the item of goods A1 entering the image capturing range of the image capturing section 2 causes a change of an electric signal from the image capturing section 2 by a prescribed amount or more, the processor 31 acquires an image at a timing at which the change is caused. In other words, when the sensing section (image capturing section 2) senses placing of the item of goods A1 on the placement surface 10, the image capturing section 2 captures an image of the item of goods A1. Note that the sensing section (image capturing section 2) may be configured to capture an image of the item of goods A1 when sensing the item of goods A1 entering a prescribed area (in this embodiment, a space on an inner side of the body 11) located above the placement surface 10.

The electric circuit 3 includes various types of circuit modules that operate with electric power supplied from the secondary battery 4. In the present embodiment, the electric circuit 3 includes, as illustrated in FIG. 4, the processor 31, the storage section 32, the communication section 33, a sensor 34, and the charging circuit 35.

The processor 31 includes a computer (including a microcontroller) as a main component. The computer includes, for example, a processor and memory. That is, the computer functions as the processor 31 by causing the processor to execute an appropriate program stored in the memory. The processor 31 has a function of controlling at least the image capturing section 2 and the communication section 33.

In the present embodiment, the processor 31 has a function as an acquirer 31. That is, when the processor 31 inputs, as input data, an image from the image capturing section 2 to a classifier, the processor 31 identifies an item of goods A1 included in the image from the image capturing section 2 and acquires goods information on the item of goods A1 thus identified. The classifier is obtained by machine learning of images of a plurality of goods A1 handled in, for example, a store as input data. Examples of the classifier may include, in addition to for example, a linear classifier such as a support vector machine (SVM), a classifier adopting a neural network or a classifier generated by deep learning by adopting a multilayer neural network.

In the present embodiment, the processor 31 does not input the image from the image capturing section 2 as is to the classifier, but the processor 31 inputs a difference image to the classifier to identify the item of goods A1. As used herein, the term “difference image” refers to an image of a difference between an image captured by the image capturing section 2 when sensing is performed by the sensing section (image capturing section 2) and an image captured by the image capturing section 2 when before the sensing, sensing is performed by the sensing section (image capturing section 2). That is, the processor 31 stores an image from the image capturing section 2 in a buffer, and each time the processor 31 newly receives an image from the image capturing section 2, the processor 31 generates a difference image representing a difference from the image stored in the buffer. The image in the buffer is overwritten with the difference image thus generated, and the difference image is then used to generate an image of a difference from an image next captured by the image capturing section 2. Note that before the item of goods A1 is put in the shopping basket 1, the buffer stores a background image (an image of the placement surface 10 on which no goods A1 are put).

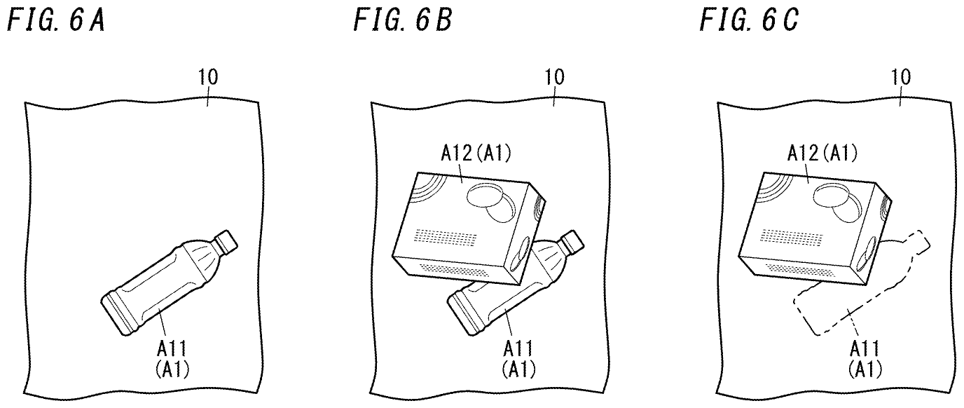

For example, it is assumed that in a state where a beverage A11 as an item of goods A1 is placed on the placement surface 10 as illustrated in FIG. 6A, food A12 as an item of goods A1 is put in the shopping basket 1 as illustrated in FIG. 6B. In this case, before the food A12 is put in the shopping basket 1, the processor 31 stores, in the buffer, an image as a difference image in which the beverage A11 is placed on the placement surface 10. When the food A12 is put in the shopping basket 1, the processor 31 generates a difference image representing a difference between an image at a time point at which the food A12 is put in the shopping basket 1 and the image stored in the buffer. In this case, the difference image is, as shown in FIG. 6C, an image in which only the food A12 is placed on the placement surface 10. The processor 31 overwrites the image in the buffer with the image (see FIG. 6B) at the time point of putting the food A12 in the shopping basket 1.

Hereafter, each time an item of goods A1 is put in the shopping basket 1, the above-described process is performed, which enables the processor 31 to input to the classifier, as input data, an image in which only the item of goods A1 newly put in the shopping basket 1 is included in the image capturing range. Thus, also when a plurality of goods A1 are put in the shopping basket 1 and the plurality of goods A1 are thus stacked on one another, the processor 31 is able to identify the plurality of goods A1 one by one.

The storage section 32 is, for example, rewritable nonvolatile memory such as electrically erasable programmable read-only memory (EEPROM) or volatile memory such as random access memory (RAM). Alternatively, the storage section 32 may be realized as a combination of nonvolatile memory and volatile memory. The storage section 32 stores at least goods information on an item of goods A1, the goods information being acquired by the processor 31. The storage section 32 is configured to store pieces of goods information on a plurality of goods A1. Therefore, when the processor 31 acquires the pieces of goods information on the plurality of goods A1, the pieces of goods information on the plurality of goods A1 are stored in the storage section 32.

The communication section 33 communicates with the store device 51, for example, via optical wireless communication using light such as infrared radiation or visible radiation as a medium or via wireless communication using a radio wave as a medium. The communication section 33 has a function of at least transmitting the respective pieces of goods information on the one or more goods A1 to the store device 51, the respective pieces of goods information being stored in the storage section 32.

The sensor 34 is, for example, an acceleration sensor and senses acceleration of the grips 12. The sensor 34 is used to sense whether the pair of grips 12 is in the first location or the second location, that is, whether or not the shopping basket 1 is in a used state. Specifically, based on a sensed result by the sensor 34, the processor 31 determines whether the pair of grips 12 is in the first location or in the second location.

For example, it is assumed that when the shopping basket 1 is stacked in the basket area, the pair of grips 12 is in an initial location (the second location). In this case, when a customer moves the pair of grips 12 to be upright to use the shopping basket 1, the sensor 34 senses acceleration higher than or equal to the prescribed acceleration. Thus, the processor 31 determines that the pair of grips 12 is moved from the second location to the first location. Thereafter, each time the processor 31 senses acceleration higher than or equal to the prescribed acceleration by using the sensor 34, the processor 31 determines that the pair of grips 12 is moved from one location to the other location. Note that when the shopping basket 1 is returned to the basket area and is supplied with electric power from the electricity supply device, the shopping basket 1 starts charging the secondary battery 4 by using the charging circuit 35. At this time, the processor 31 resets the location of the pair of grips 12 to the initial location (the second location).

In the present embodiment, when the processor 31 determines, based on the sensed result by the sensor 34, that the pair of grips 12 is in the first location, the processor 31 activates the image capturing section 2. In contrast, when the processor 31 determines, based on the sensed result by the sensor 34, that the pair of grips 12 is in the second location, the processor 31 stops the image capturing section 2. That is, when the grips 12 is in the first location, the image capturing section 2 is in a state where the image capturing section 2 is available to capture an image, and when the grips 12 is in the second location, the image capturing section 2 is in a state where the image capturing section 2 is unavailable to capture an image.

The charging circuit 35 receives electric power from the power supply apparatus to charge the secondary battery 4. In this embodiment, the charging circuit 35 includes a DC/DC converter configured to step down a direct-current voltage applied from the power supply apparatus.

### (3) Operation

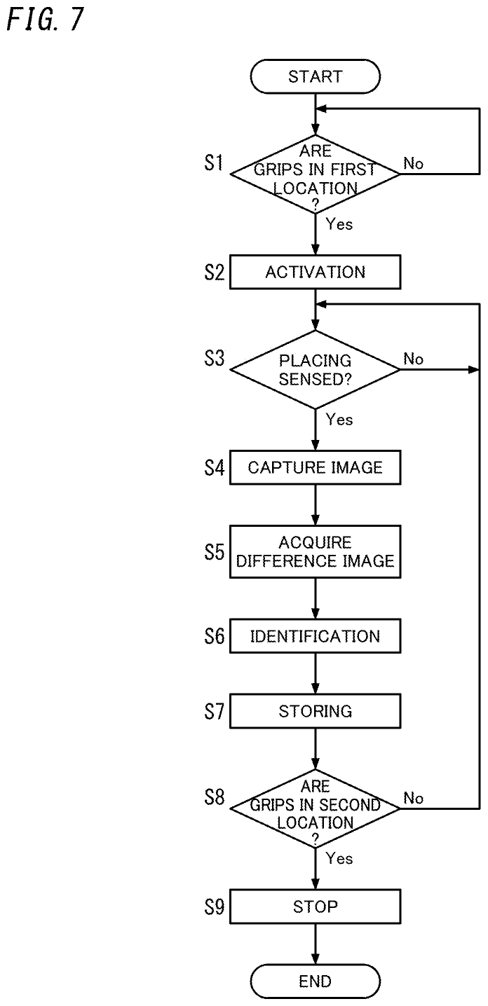

Operation of the item information acquisition system 100 of the present embodiment will be described with reference to FIG. 7. First, a customer holds the pair of grips 12 of the shopping basket 1 stacked in the basket area with a hand, thereby moving the pair of grips 12 from the second location to the first location. Thus, the processor 31 determines, based on the sensed result by the sensor 34, that the pair of grips 12 is in the first location (S1: Yes), the processor 31 activates the image capturing section 2 (S2). Thereafter, the customer puts an item of goods A1, which the customer wishes to purchase, in the shopping basket 1 while the customer moves in the store. When the processor 31 senses, by using the sensing section (image capturing section 2), that the item of goods A1 is put in the shopping basket 1 (that is, the item of goods A1 is placed on the placement surface 10) (S3: Yes), the processor 31 causes the image capturing section 2 to capture an image of the item of goods A1 (S4). Thus, the processor 31 acquires an image of the item of goods A1 placed on the placement surface 10 at a time point at which the item of goods A1 is put in the shopping basket 1.

Thereafter, the processor 31 generates a difference image between the image acquired in step S4 and an image stored in the buffer before step S4 to acquire a difference image (S5). Then, the processor 31 inputs the difference image as input data to the classifier, thereby identifying the item of goods A1 included in the difference image and acquires goods information on the item of goods A1 thus identified (S6). That is, the processor 31 acquires the goods information on the item of goods A1 put in the shopping basket 1 in step S3. Then, the processor 31 stores the goods information thus acquired on the item of goods A1 in the storage section 32 (S6).

Hereafter, until the customer puts all the goods A1 that the customer wishes to purchase in the shopping basket 1, and the customer disposes the shopping basket 1 on the counter desk 53, that is, until the processor 31 determines that the pair of grips 12 is in the second location, the shopping basket 1 repeats the process from steps S3 to S7. When the processor 31 determines that the pair of grips 12 is in the second location (S8: Yes), the processor 31 stops the image capturing section 2 (S9).

When the shopping basket 1 is disposed on the counter desk 53, the processor 31 transmits respective pieces of goods information on the one or more goods A1 via the communication section 33 to the store device 51, the respective pieces of goods information being stored in the storage section 32 of the shopping basket 1. Thus, the store device 51 acquires the respective pieces of goods information on the one or more goods A1 put in the shopping basket 1.

Here, in the present embodiment, the counter desk 53 includes an image capture device 55 having an image capturing range corresponding to the placement surface 10 of the shopping basket (carrier) 1 disposed on the counter desk 53. As illustrated in FIG. 5, the image capture device 55 is attached to an arch 54 installed on an upper surface of the counter desk 53. The arch 54 includes a pair of supports 541 and a beam 542. The pair of supports 541 is installed on the upper surface of the counter desk 53 to straddle the shopping basket 1 disposed on the counter desk 53 and rises upward from the upper surface. The beam 542 connects respective upper ends of the pair of supports 541. The image capture device 55 is attached to a center portion in the lengthwise direction of the beam 542.

Similarly to the processor 31, the store device 51 includes an identification device configured to identify a plurality of goods A1 handled in a store. Unlike the identification device of the processor 31, the identification device is preferably configured to individually identify the plurality of goods A1 based on an image, as the input data, including the plurality of goods A1 placed on the placement surface 10. The store device 51 inputs, as the input data, an image captured by using the image capture device 55 to the classifier, thereby identifying one or more goods A1 put in the shopping basket 1 (that is, one or more goods A1 placed on the placement surface 10) and acquiring respective pieces of goods information on the one or more goods A1. That is, the sales system 5 (store device 51) identifies, based on the image captured by the image capture device 55, the one or more goods (items) A1 placed on the placement surface 10.

When the respective pieces of goods information on the one or more goods A1 acquired by using the store device 51 match the respective pieces of goods information on the one or more goods A1 acquired from the shopping basket 1, the store device 51 executes checkout processing. When the respective pieces of goods information on the one or more goods A1 acquired by using the store device 51 do not match the respective pieces of goods information on the one or more goods A1 acquired from the shopping basket 1, the store device 51 executes sales processing of only one or some of the one or more goods A1 whose pieces of goods information match the respective pieces of goods information acquired from the shopping basket 1. The one or more goods A1 whose pieces of goods information do not match the respective pieces of goods information acquired from the shopping basket 1 are separately subjected to checkout processing performed by, for example, a clerk. As described above, in the present embodiment, the shopping basket 1 and the sales system 5 execute respective identification processes of the one or more goods A1 to increase the identification accuracy of the one or more goods A1.

As described above, in the present embodiment, when viewed in the direction orthogonal to the placement surface 10, the image capturing section 2 is located on an inner side of the peripheral edge 111 of the body (placement section) 11 but not at the peripheral edge 111 of the body (placement section) 11. Thus, in the present embodiment, a blind spot is less likely to be generated in the image capturing range of the image capturing section 2 on the placement surface 10 on which one or more goods (items) A1 are to be placed.

For example, it is assumed that when the shopping basket 1 is viewed from the upper side in FIG. 2A, the image capturing section 2 is disposed to be located above the flange 13. In this case, in the placement surface 10, a blind spot of the image capturing range of the image capturing section 2 is more likely to be generated in the periphery of one side which is included in four sides of the flange 13 and above which the image capturing section 2 being located. In this case, if the one or more goods A1 are present in the blind spot of the image capturing range of the image capturing section 2, it is not possible to identify the one or more goods A1, and respective pieces of goods information on the one or more goods A1 may not be acquired.

On the other hand, in the present embodiment, when the shopping basket 1 is viewed from the upper side in FIG. 2A, the image capturing section 2 is located on the inner side of the placement surface 10. Thus, in the placement surface 10, a blind spot of the image capturing range of the image capturing section 2 is less likely to be generated. Thus, the present embodiment provides the advantage that the image capturing section 2 easily captures an entire image of one or more goods A1 regardless of locations in which the one or more goods A1 are placed on the placement surface 10, and as a result, the one or more goods (items) A1 are easily identified based on an image capturing result by the image capturing section 2.

Then, in the present embodiment, a customer (user) simply puts one or more goods (items) A1 in the shopping basket (carrier) 1, which enables acquisition of respective pieces of goods information (item information) on the one or more goods A1 thus input (that is, the one or more goods A1 placed on the placement surface 10). Thus, in the present embodiment, when a customer puts one or more goods A1 in the shopping basket 1, the customer does not have to cause a reading unit (for example, a barcode reader) to read respective pieces of goods information on the one or more goods A1. This provides the advantage that convenience for customers can be improved.

### (4) Variation

The above-described embodiment is a mere example of various embodiments of the present disclosure. The above-described embodiment may be modified in various ways depending on design and the like as long as the object of the present disclosure can be achieved. Moreover, a function similar to that of the item information acquisition system 100 may be realized by an item information acquisition method, a computer program, a storage medium in which the program is recorded, or the like. Furthermore, functions similar to those of the shopping assistance system 200 may be realized by a shopping assistance method, a computer program, a storage medium in which the program is recorded, or the like.

A shopping assistance method according to one aspect is a shopping assistance method in which a carrier 1 is adopted. The carrier 1 includes a placement section 11, a projection 12, and an image capturing section 2. The placement section 11 includes a placement surface 10 on which one or more items A1 as carriage targets are to be placed. The projection 12 protrudes from the placement section 11 in a direction transverse to the placement surface 10. The image capturing section 2 is held by the projection 12 and has an image capturing range corresponding to at least the placement surface 10. The image capturing section 2 is disposed spaced away from an entire perimeter of a peripheral edge 111 of the body (placement section) 11 when viewed in a direction orthogonal to the placement surface 10. The shopping assistance method includes capturing, by using by the image capturing section 2, an image of the placement surface 10 on which the one or more items A1 are placed. The shopping assistance method further includes identifying the one or more items A1 placed on the placement surface 10 based on the image captured by the image capturing section 2 to acquire respective pieces of item information on the one or more items A1. Moreover, the shopping assistance method includes performing a sales process of the one or more items A1 placed on the placement surface 10 based on the item information.

Variations of the above-described embodiment will be described below. Various variations described below may be combined as appropriate.

### (4.1) First Variation

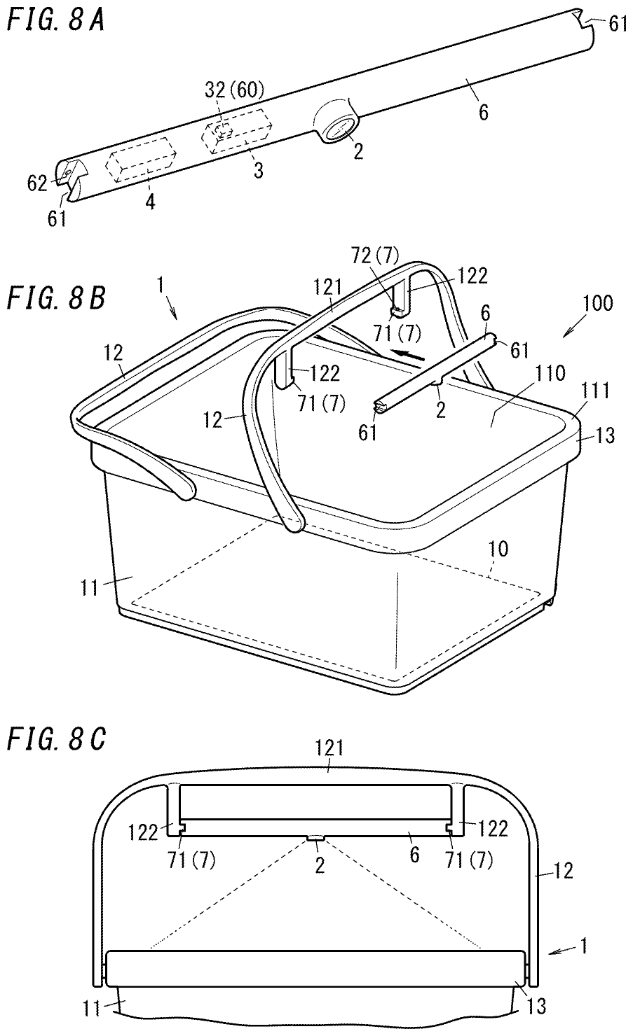

An item information acquisition system 100 of a first variation is different from the item information acquisition system 100 of the above-described embodiment in that a terminal 6 includes an image capturing section 2, an electric circuit 3, and a secondary battery 4 as illustrated in FIGS. 8A to 8C. The terminal 6 is portable and is freely detachably provided to part of a grip 12. Moreover, in the present variation, the grip 12 has a pair of projections 122. Each of the pair of projections 122 is provided with a corresponding one of a pair of attachments 7. Each of ends in a lengthwise direction of the terminal 6 is to be freely detachably attached to a corresponding one of the pair of attachments 7. That is, a shopping basket (carrier) 1 includes a cooperation device (pair of attachments) 7 that cooperates with the terminal 6 which is portable.

The terminal 6 has a bar shape and incudes the electric circuit 3 and the secondary battery 4 therein. Moreover, the image capturing section 2 is integrally provided with a central part in the lengthwise direction of the terminal 6. The ends in the lengthwise direction of the terminal 6 have respective slits 61. Each of the slits 61 has an inside wall in which a recess 62 is formed. In the recess 62, a projection portion 72 (which will be described later) of each of the attachments 7 is to be fit. Moreover, the inside wall of each slit 61 is provided with a switch which is turned on when pushed by a claw 71 (which will be described later) of the attachment 7. The electric circuit 3 of the terminal 6 operates when the switch is turned on. That is, the terminal 6 is configured to operate when attached to the pair of attachments 7 of the grip 12.

The electric circuit 3 has a storage section 32 which stores user information. In other words, the terminal 6 includes a storage section 60 (storage section 32) which stores at least user information of a user of the terminal 6. The user information is personal information regarding a user who possesses the terminal 6. The user information includes, for example, information of instruction of an electronic billing service used, for example, when checkout processing of goods A1 is performed. Examples of the electronic billing service include a service by using a credit card, a prepaid card, or electronic money. The electric circuit 3 includes a processor 31 which refers user information stored in the storage section 60 in a state where the terminal 6 is in operation.

Each attachment 7 includes the claw 71 and the projection portion 72. The claw 71 protrudes from a lower end of each of the pair of projections 122 and is configured to be slid to be fit in the slit 61 of the terminal 6. The projection portion 72 protrudes upward from the claw 71 and is configured to be fit in the recess 62 in a state where the claw 71 is fit in the slit 61.

In this aspect, attaching the terminal 6 to the shopping basket 1 enables the terminal 6 and the shopping basket 1 to function as the item information acquisition system 100. That is, the terminal 6 does not have to be attached all the time to the shopping basket, and therefore, a customer (user), but not a store, can manage the terminal 6. Thus, this aspect enables the terminal 6 to manage, as described above, the personal information (user information) of a customer (user).

Moreover, in this aspect, the grip 12 of the shopping basket 1 has at least the attachments (cooperation device) 7, and the entirety of the shopping basket 1 does not have to be designed based on a particular specification suitable to the item information acquisition system 100. Thus, the aspect is applicable, for example, to shopping baskets 1 widely used in convenience stores. Moreover, this aspect is applicable to various types of shopping baskets 1 different form each other in specification such as the size.

Moreover, in the aspect, the processor 31 refers to the user information stored in the storage section 60 of the terminal 6 to communicate with a sales system 5, and thereby, it is possible to automatically complete the checkout process in the electronic billing service specified by a customer (user).

### (4.2) Second Variation

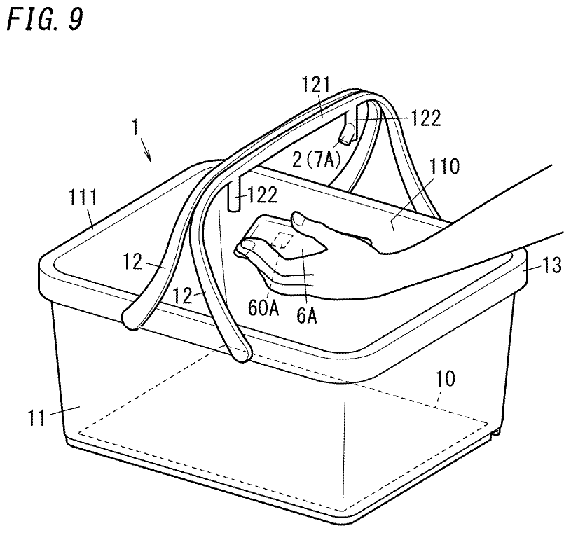

An item information acquisition system 100 of a second variation is different from the item information acquisition system 100 of the above-described embodiment in that an image capturing section 2 reads a QR code (registered trademark) displayed on a display of a terminal 6A which is portable as illustrated in FIG. 9. In the present variation, the image capturing section 2 corresponds to a cooperation device 7A that cooperates with the terminal 6A, which is portable.

The terminal 6A is, for example, a portable information terminal such as a smartphone. Similarly to the first variation, the terminal 6A has memory 60A which stores user information. That is, the terminal 6 includes the memory (storage section) 60A that stores at least user information of a user of the terminal 6A. A QR code (registered trademark) displayed on a display of the terminal 6A includes the user information stored in the memory 60A. Thus, a processor 31 is configured to read the QR code (registered trademark) by using the image capturing section 2 to refer to the user information in a manner similar to the first variation.

Similarly to the first variation, in this aspect, the processor 31 refers to the user information stored in the storage section 60A of the terminal 6A to communicate with a sales system 5, and thereby it is possible to automatically complete a checkout process in an electronic billing service specified by a customer (user).

### (4.3) Third Variation

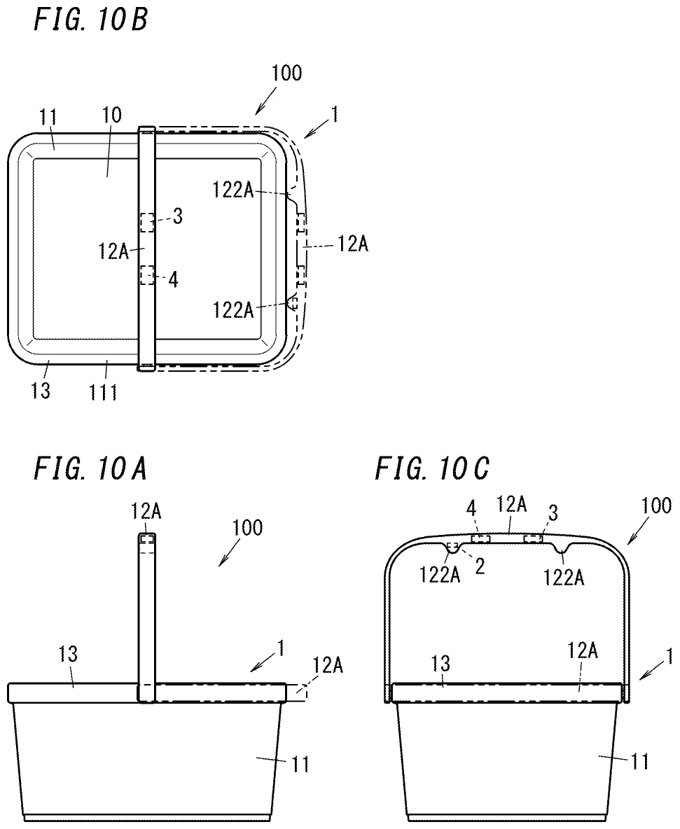

An item information acquisition system 100 of a third variation is different from the item information acquisition system 100 of the above-described embodiment in that a shopping basket 1 includes one grip 12A as illustrated in FIGS. 10A to 10C in place of the pair of grips 12. That is, in the present variation, the shopping basket (carrier) 1 has one grip 12A. The grip 12A includes a pair of projections 122A. When the grip 12A is in the first location, the pair of projections 122A protrudes downward in FIG. 10C (that is, in a direction from an opening section 110 toward a placement surface 10). One projection 112A of the pair of projections 122A has an opening. An image capturing section 2 is configured to capture an image of the placement surface 10 through the opening. The grip 12 is designed such that in a state where a customer grips the grip 12A, the position of the shopping basket 1 can be maintained so that one or more goods A1 put in the shopping basket 1 do not fall out of the shopping basket 1.

This aspect enables the distance between the image capturing section 2 and the placement surface 10 to be longer than that in a case where the shopping basket 1 has the pair of grips 12. That is, in the case where the shopping basket 1 has the pair of grips 12, the pair of grips 12 in the first location is tilted to the placement surface 10, and therefore, it is difficult to gain the distance between the image capturing section 2 and the placement surface 10. In contrast, in the present variation, the grip 12A in the first location can be upright to the placement surface 10, and therefore, it is easy to gain the distance between the image capturing section 2 and the placement surface 10. Thus, this aspect provides the advantage that the image capturing range of the image capturing section 2 is more easily extended than in the case where the shopping basket 1 has the pair of grips 12. Moreover, this aspect provides the advantage that the grip 12 is less likely to be an obstacle and one or more goods A1 are more easily put in the shopping basket 1 than in the case where the shopping basket 1 has the pair of grips 12.

### (4.4) Fourth Variation

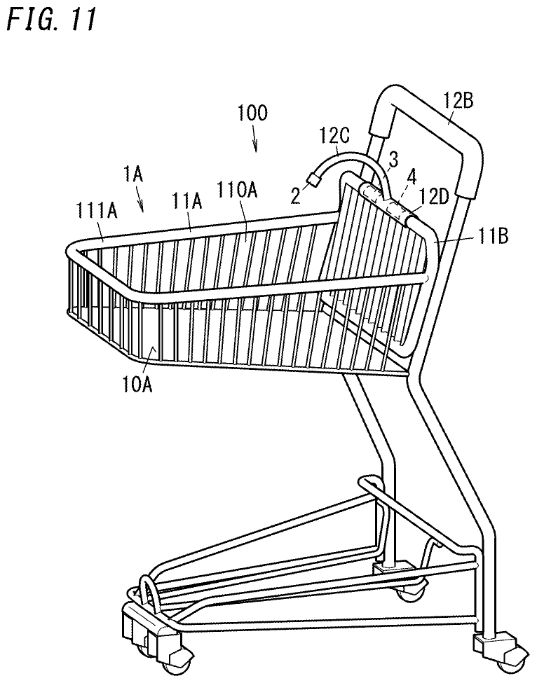

An item information acquisition system 100 of a fourth variation is different from the item information acquisition system 100 of the above-described embodiment in that a cart 1A instead of the sopping basket 1 serves as the carrier as illustrated in FIG. 11. The cart 1A is used in, for example, stores such as supermarkets.

Similarly to the shopping basket 1, the cart 1A includes a body (placement section) 11A and a grip 12B. The body 11A includes a placement surface 10A on which one or more goods A1 are to be placed. A portion 11B of portions forming a frame surrounding an opening section 110A of the body 11A is closest to the grip 12B, and an attachment 12D which is semicircular and tubular is attached to the grip 12B. The attachment 12D includes an electric circuit 3 and a secondary battery 4 therein. Moreover, the attachment 12D is integrally provided with a projection 12C which is curved and projects toward the opening section 110A. The projection 12C has one end which faces the opening section 110A and which is provided with an image capturing section 2. That is, in the present variation, the projection 12C is provided separately from the grip 12B of the cart 1A.

Similarly to the above-described embodiment, in this aspect, the image capturing section 2 is located on an inner side of the placement surface 10A when the cart 1A is viewed from the upper side in FIG. 11. Thus, in the placement surface 10A, a blind spot of the image capturing range of the image capturing section 2 is less likely to be generated. Thus, this aspect provides the advantage that the image capturing section 2 easily captures an entire image of one or more goods A1 regardless of locations in which the one or more goods A1 are placed on the placement surface 10A, and as a result, the one or more goods (items) A1 are easily identified based on an image capturing result by the image capturing section 2.

### (4.5) Other Variations

Variations other than the first to fourth variations will be recited below. Various types of variations below are applicable accordingly in combination with the above-described embodiment and the first to fourth variations.

An item information acquisition system 100 of the present disclosure includes a computer system (including a microcontroller) in a processor (acquirer) 31 or the like. The microcontroller includes one or more semiconductor chips and is one aspect of a computer system having at least a processor function and a memory function. The computer system includes a processor and memory as hardware as main components. The processor executes a program stored in the memory of each computer system, thereby realizing the function as the item information acquisition system 100 of the present disclosure. The processor executes a program stored in the memory of each computer system, thereby realizing the function as the item information acquisition system 100 of the present disclosure. The program may be stored in the memory of the computer system in advance, may be provided over a telecommunications network, or may be provided as a recording medium such as a computer-system readable memory card, an optical disk, a hard disk drive, or the like storing the program. The processor of the computer system includes one or a plurality of electronic circuits including semiconductor integrated circuits (IC) or large-scale integrated circuits (LSI). The integrated circuit such as IC or LSI mentioned herein may be referred to in another way, depending on the degree of the integration and includes integrated circuits called system LSI, very-large-scale integration (VLSI), or ultra-large-scale integration (ULSI). A field-programmable gate array (FPGA), which is programmable after fabrication of the LSI, or a logical device which allows reconfiguration of connections in LSI or reconfiguration of circuit cells in LSI may be adopted as the processor. The plurality of electronic circuits may be collected on one chip or may be distributed on a plurality of chips. The plurality of chips may be collected in one device or may be distributed in a plurality of devices. As mentioned herein, the computer system includes a microcontroller including one or more processors and one or more memories. Thus, the microcontroller is also composed of one or more electronic circuits including a semiconductor integrated circuit or a large-scale integrated circuit.

In the first variation, the terminal 6 includes the image capturing section 2, the electric circuit 3, and the secondary battery 4 disposed therein, but this should not be construed as limiting. For example, the image capturing section 2, the electric circuit 3, and the secondary battery 4 may be disposed in the grip 12. In this aspect, the terminal 6 includes only the storage section 60 disposed therein and may be configured to be electrically connected to the electric circuit 3 and the like provided in the grip 12 when the terminal 6 is attached to the cooperation device 7.

In the first variation, the terminal 6 may have a fingerprint authentication function and may be configured to operate only when authentication is successfully performed. In this case, even if a user forgets to detach the terminal 6 from the grip 12, other users than the user of the terminal 6 are not allowed to operate the terminal 6, and therefore, it is possible to prevent the terminal 6 from being used by others.

In the second variation, the cooperation device 7A is configured to read a QR code (registered trademark) displayed on the display of the terminal 6A, but this should not be construed as limiting. For example, the cooperation device 7A may be configured to communicate with the terminal 6A based on a near field communication technique such as near field communication (NFC). Also this aspect enables the processor 31 to refer to user information stored in the storage section 60A of the terminal 6A via the cooperation device 7A.

In the first variation and the second variation, the processor 31 refers to the user information stored in the storage section 60, 60A of the terminal 6, 6A, but this should not be construed as limiting. For example, when the terminal 6, 6A has a function of cooperating with an electric appliance possessed by a user of the terminal 6, 6A, the terminal 6, 6A is configured to acquire apparatus information on the electric appliance and store the apparatus information in the storage section 60, 60A. Examples of the electric appliance include a refrigerator and an artificial intelligence (AI) loudspeaker. In this case, the processor 31 cooperates with the terminal 6, 6A to be able to refer to the apparatus information stored in the storage section 60, 60A.

The apparatus information is, for example, information acquired by an electric appliance when a user uses the electric appliance, the information relating to the user. Specifically, when the electric appliance is a refrigerator, the apparatus information is, for example, information on food (item A1) to be supplied to the refrigerator. Alternatively, when the electric appliance is an AI loudspeaker, the apparatus information is information which is obtained by analyzing voice information from a user by using the AI loudspeaker and which denotes an item A1 satisfying the needs of the user. Thus, in this aspect, the processor 31 is configured to refer to the apparatus information to present information to a customer (user) by using an appropriate means such as voice or display, the information denoting an item of goods (item) A1 to be purchased (obtained).

In the above-described embodiment, the projection 122 protruding from the handle portion 121 of the grip 12 has the image capturing section 2, but this should not be construed as limiting. For example, the handle portion 121 of the grip 12 may have the image capturing section 2.

In the above-described embodiment, the sensor 34 is an acceleration sensor, but this should not be construed as limiting. For example, the sensor 34 may be a physical switch which is provided to the peripheral edge 111 of the body 11 and which is configured to be turn on and off when the physical switch is brought into contact with at least one grip 12 of the pair of grips 12. In this aspect, it is possible to determine, based on ON/OFF of the sensor 34, whether the pair of grips 12 is at a location in which the pair of grips 12 is in contact with the sensor 34 (that is, a first location) or the pair of grip 12 is at a location away from the sensor 34 (that is, a second location). Alternatively, the sensor 34 may be a pressure sensor which is provided to the peripheral edge 111 of the body 11 and which is configured to sense pressure when at least one grip 12 of the pair of grips 12 comes into contact with the sensor 34. Also in this aspect, based on whether or not the sensor 34 senses pressure, it is possible to determine whether the pair of grips 12 is in the location where the pair of grips is in contact with the sensor 34 (that is, the first location) or the pair of grips 12 is in the location away from the sensor 34 (that is, the second location).

In the above-described embodiment, the processor 31 senses the location of the pair of grips 12 by using the sensor 34 and activates or stops the image capturing section 2 in accordance with a result of the sensing, but this should not be construed as limiting. For example, the shopping basket 1 does not have to have the sensor 34. Alternatively, the image capturing section 2 may be always in an activated state.

In the above embodiment, the shopping basket 1 includes one image capturing section 2, but this should not be construed as limiting. For example, the shopping basket 1 may have a stereo camera including a plurality of image capturing sections 2. In this case, the processor 31 is configured to acquire, from the stereo camera, depth information in a direction orthogonal to the placement surface 10, which enables the identification accuracy of goods A1 to be increased.

In the above-described embodiment, the processor 31 identifies the one or more goods A1 placed on the placement substrate 10 based on only respective images captured by the image capturing section 2, but this should not be construed as limiting. For example, the processor 31 may identify the one or more goods A1 placed on the placement surface 10 based on a combination of respective images captured by the image capturing section 2 and sensed results by a sensing section other than the image capturing section 2. In this case, the sensing section is preferably configured as, for example, a weight sensor that senses a feature (in this case, weight) of each of the one or more goods A1.

In the above-described embodiment, a communication scheme between the shopping basket 1 and the sales system 5 (store device 51) is wireless communication but may be wired communication. In the case of the wired communication, more pieces of information can be transmitted at a time from the shopping basket 1 to the sales system 5(store device 51) than in the case of the wireless communication.

In the above-described embodiment, at a timing at which the shopping basket 1 is disposed on the counter desk 53, respective pieces of goods information on one or more goods A1 stored in the storage section 32 of the shopping basket 1 are transmitted to the store device 51, but this should not be construed as limiting. For example, at a timing at which the processor 31 acquires goods information on an item of goods A1, the processor 31 may transmit the goods information on the item of goods A1 to the store device 51 by wireless communication by using the communication section 33. That is, the store device 51 collects pieces of goods information on goods A1 put in the shopping basket 1 in real time and may store, in memory, the pieces of goods information thus collected and relating to the goods A1.

In this aspect, when a customer disposes the shopping basket 1 on the counter desk 53, the store device 51 preferably acquires an identifier (address) of the shopping basket 1. Specifically, the store device 51 reads, by using a reader provided to the counter desk 53, an electronic tag attached to the shopping basket 1, thereby acquiring the identifier of the shopping basket 1. The electronic tag is preferably compatible with a communication standard such as radio frequency identification (RFID) or the Infrared Data Association (IrDA). The store device 51 reads respective pieces of goods information on the one or more goods A1 associated with the identifier of the shopping basket 1 from memory and refers to the respective pieces of goods information on the one or more goods A1 read, thereby executing checkout processing. That is, when a plurality of shopping baskets 1 are present in a store, the store device 51 associates respective pieces of goods information on one or more goods A1 transmitted from each of the plurality of shopping baskets 1 with the identifier of the shopping basket 1 as a transmission source and stores the respective pieces of goods information in memory. When the shopping basket 1 is placed on the counter desk 53, the store device 51 refers to the identifier of the shopping basket 1, thereby executing checkout processing of the one or more goods A1 put in the shopping basket 1.

In this aspect, when the checkout processing is completed, the store device 51 deletes, from the memory, the respective pieces of goods information on the one or more goods A1 put in the shopping basket 1 as targets of the checkout processing. Then, when a customer returns the shopping basket 1 to the basket area, the processor 31 determines that the grip 12 is in the second location, and the processor 31 stops the operation of the image capturing section 2. At this time, the processor 31 deletes the respective pieces of goods information on the one or more goods A1 stored in the storage section 32. A timing at which the processor 31 deletes the respective pieces of goods information on the one or more goods A1 may be a time point at which the checkout processing is completed.

Moreover, in the above-described embodiment, the sales system 5 is mounted on the counter desk 53, but this should not be construed as limiting. For example, the sales system 5 (store device 51) may be realized as a computer system installed in a store. In this case, the processor 31 of the shopping basket 1 communicates with the sales system 5 by using the communication section 33, and thereby, it is possible to complete the checkout processing without disposing the shopping basket 1 on the counter desk 53. In this case, since a customer does not have to place the shopping basket 1 on the counter desk 53, it is possible for the customer to finish shopping without going to the front of, for example, the counter desk 53.

In the above-described embodiment, when the processor (acquirer) 31 fails to acquire goods information on an item of goods A1, the processor 31 may notify an error by reproducing a voice message such as “please put the item of goods in the shopping basket again”. In this aspect, it is possible to prompt a customer (user) to put the item of goods A1 in the shopping basket 1 again and to cause the processor 31 to perform the identification process of the item of goods A1 again. Note that when the processor 31 fails to acquire goods information on an item of goods A1, the processor 31 may execute the identification process of the item of goods A1 again instead of notifying the error. That is, when the processor (acquirer) 31 fails to identify an item of goods (item) A1, the processor 31 may notify the error or may execute the identification process of the item of goods A1 again.

In the above-described embodiment, the image capturing section 2 functions as a sensing section, but this should not be construed as limiting. For example, as a sensing section, a transmission optical sensor, a reflection optical sensor, or an ultrasonic sensor may be mounted on the shopping basket 1. In this case, when the processor 31 senses, by using the above-described optical sensor or ultrasonic sensor, passing of the item of goods A1 through the opening section 110 of the shopping basket 1, the processor 31 determines that the item of goods A1 is placed on the placement surface 10.

In the above-described embodiment, the arch 54 and the image capture device 55 are provided to the counter desk 53, but this should not be construed as limiting. For example, the counter desk 53 does not have to be provided with the arch 54 or the image capture device 55. In this case, the sales system 5 does not execute the identification process of identifying the one or more goods A1 placed on the placement surface 10 of the shopping basket 1. That is, in the above-described embodiment, a process of acquiring the goods information on the item of goods A1 may be completed in the shopping basket 1.

In the above-described embodiment, the processor (acquirer) 31 is provided to the shopping basket (carrier) 1, but this should not be construed as limiting. For example, the processor 31 may be provided to the store device 51. In this case, in the shopping basket (carrier) 1, an image (difference image) captured by the image capturing section 2 is transmitted to the store device 51 via the communication section 33. The store device 51 identifies an item of goods (item) A1 based on the image captured by the image capturing section 2 and acquires goods information (item information) on the item of goods A1.

Alternatively, the processor 31 may be realized by, for example, a server system or cloud (cloud computing). For example, the shopping basket (carrier) 1 may transmit an image (difference image) captured by the image capturing section 2 to a server system via the communication section 33. The server system may identify an item of goods (item) A1 based on the image captured by the image capturing section 2 and acquire goods information (item information) on the item of goods A1.

In the above-described embodiment, the shopping assistance system 200 may be used not only in a situation in which purchase of goods is possible without an operation given by a clerk but for example. The shopping assistance system 200 may also be used in a situation in which a clerk is at a counter desk 53 as in the case of a so-called manned checkout counter. Alternatively, the shopping assistance system 200 may be used in, for example, a store without a clerk.

In the above-described embodiment, the item information acquisition system 100 is used to acquire state information of the shopping basket (carrier) 1, but the application of the item information acquisition system 100 is not limited to this example. For example, the item information acquisition system 100 may be used to acquire state information on the basket (carrier) 1 accommodating one or more items picked up in a distribution warehouse. Alternatively, the item information acquisition system 100 may be used to acquire state information on a basket accommodating one or more components picked up in a factory or a tray on which the component is to be mounted.

In the above-described embodiment, the shopping basket (carrier) 1 may be carried by a person or may be carried by, for example, robot.

### Second Embodiment

### (1) Schema

First, a schema of an item identification system 300 according to the present embodiment will be described with reference to FIGS. 1, 2A, 2B, 12, and 13. The item identification system 300 of the present embodiment is a system for identifying an item A1 placed in a carrier 1. The item identification system 300 is assumed to be introduced, together with a sales system 5, in a store and forms a shopping assistance system 200 to assist a customer in shopping.

Here, the item identification system 300 of the present embodiment adopts the following configuration to identify an item of goods (item) A1 accommodated in a shopping basket (a carrier) 1. That is, the item identification system 300 includes an image capturing section 2 and an identification section 31.

The image capturing section 2 is provided to the shopping basket (carrier) 1. The image capturing section 2 is held by one grip 12 of a pair of grips 12, and the image capturing range of the image capturing section 2 corresponds at least to a placement surface 10. That is, the image capturing section 2 is configured to capture an image of an item of goods A1 placed in the shopping basket (carrier) 1, in other words, an item of goods A1 placed on the placement surface 10 or an item of goods A1 mounted on the item of goods A1 placed on the placement surface 10.

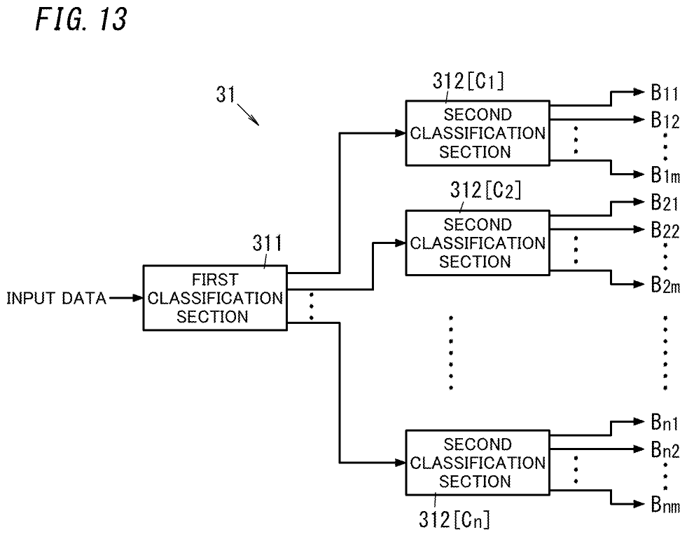

The identification section 31 is a processor included in the shopping basket 1 and is configured to identify the item of goods A1 placed on the shopping basket 1. In the following description, the identification section 31 is also referred to as a “processor 31” unless otherwise indicated. As illustrated in FIG. 13, the identification section 31 includes a first classification section 311 and a plurality of second classification sections 312. In the present embodiment, the identification section 31 includes “n” second classification sections 312 (where “n” is an integer larger than or equal to 2).

The first classification section 311 classifies, based on information regarding the item of goods (item) A1, the item of goods A1 into one or more categories of a plurality of categories C₁, . . . , Cₙ. As used herein, the term “category” refers to classification based on the features of goods A1. Examples of the category include the product type, such as a beverage, confectionery, or articles of daily use, of the goods A1, the shape of the goods A1, or the size of the goods A1. That is, the first classification section 311 extracts the feature of the item of goods A1 based on the information regarding the item of goods A1. The first classification section 311 determines, based on the feature of the item of goods A1, a category to which the item of goods A1 belongs. In the present embodiment, the first classification section 311 classifies the item of goods A1 into any one category of the plurality of categories C₁, . . . , Cₙ.

Each of the plurality of second classification sections 312 is provided to a corresponding one of the plurality of categories C₁, . . . , Cₙ. In other words, the plurality of second classification sections 312 correspond to the plurality of categories C₁, . . . , Cₙ on a one-to-one basis. Each of the plurality of second classification sections 312 further classifies the item of goods A1 classified into the one or more categories, by using a machine-learned classifier, based on an image of an item of goods (item) A1 captured by an image capturing section 2. In the present embodiment, the classification of the item of goods A1 by the second classification section 312 corresponds to the identification of the item of goods A1. For example, when any second classification section 312 corresponds to the category of a beverage, the second classification section 312 identifies, based on the image of the item of goods A1 captured by the image capturing section 2, which beverage the item of goods A1 is. As a specific example, if the item of goods A1 imaged by the image capturing section 2 is a carbonated drink with a specific name, the above-described second classification section 312 identifies that the item of goods A1 is a carbonated drink with the specific name.

As described above, in the present embodiment, first, the first classification section 311 classifies an item of goods (item) A1 into one or more categories. Then, in the present embodiment, the item of goods (item) A1 classified into the one or more categories is subjected to a classification process (identification process) of the item of goods A1 based on the image of the item of goods A1 captured by the image capturing section 2. Thus, in the present embodiment, a process load of the classifier of each of the first classification section 311 and the second classification section 312 is lower than that in a case where one classifier performs the identification process of the item of goods A1 that belongs to all the categories C₁, . . . , Cₙ, As a result, the present embodiment has the advantage that even when the number of types of the goods A1 as identification targets increases, a required time for identification of the goods A1 is less likely to be increased. (2) Details

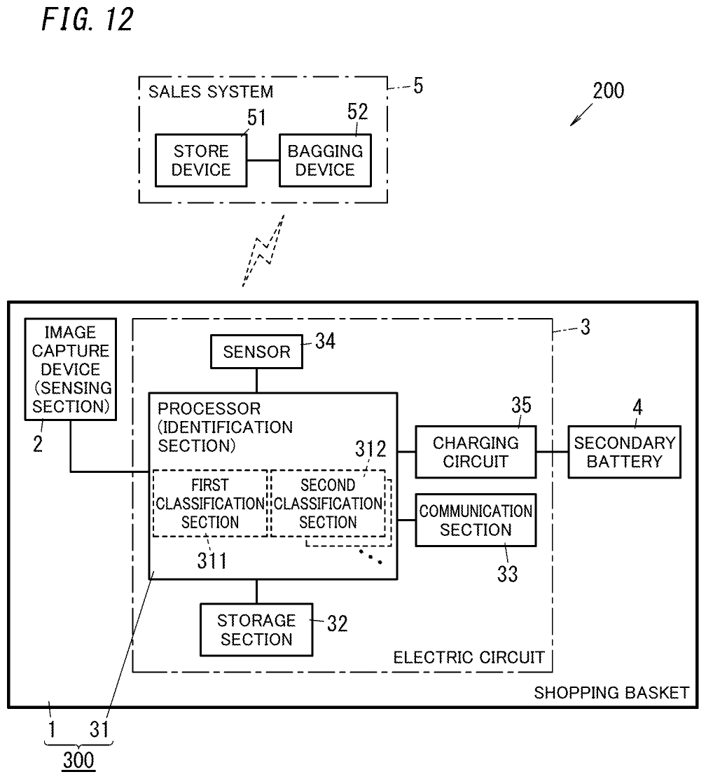

A configuration of the item identification system 300 according to the present embodiment will be explained in detail below. Note that description of points common with the item information acquisition system 100 of the first embodiment will be omitted below. As illustrated in FIG. 12, the item identification system 300 of the present embodiment includes the shopping basket 1 and the processor 31.

In the present embodiment, the processor 31 has a function as an identification section 31. That is, when the processor 31 inputs, as input data, an image from the image capturing section 2 to a machine-learned classifier, the processor 31 identifies an item of goods A1 included in the image from the image capturing section 2 and acquires goods information on the item of goods A1 thus identified. The classifier is obtained by, for example, machine learning of images of a plurality of goods A1 handled in a store as input data. Examples of the classifier may include, in addition to for example, a linear classifier such as a support vector machine (SVM), a classifier adopting a neural network or a classifier generated by deep learning by adopting a multilayer neural network.

In the present embodiment, the processor 31 includes, as illustrated in FIG. 13, the first classification section 311 and the plurality of (in this embodiment, “n”) second classification sections 312. Moreover, in the present embodiment, the first classification section 311 and the plurality of second classification sections 312 have respective classifiers which adopt learned neural networks different from each other. Examples of the learned neural network may include, for example, a convolutional neural network (CNN), a Bayesian neural network (BNN), or the like.

Each of the first classification section 311 and the plurality of second classification sections 312 is realized by mounting the learned neural network on an integrated circuit such as an application specific integrated circuit (ASIC) or a field-programmable gate array (FPGA). In the present embodiment, each of the first classification section 311 and the plurality of second classification sections 312 is mounted on one substrate but may be distributed on a plurality of substrates.

The first classification section 311 classifies the item of goods A1 into one category of the plurality of categories C₁, . . . , Cₙ, based on an image, as input data, which includes an item of goods A1 and which is captured by the image capturing section 2. That is, in the present embodiment, the image, which includes the item of goods A1 and which is captured by the image capturing section 2, is information regarding the item of goods (item) A1. In other words, the information regarding the item of goods A1 includes image information of the item of goods A1 captured by the image capturing section 2. In the present embodiment, the plurality of categories C₁, . . . , Cₙ, are product types of goods A1. That is, the first classification section 311 classifies the item of goods A1 into any one product type, such as a beverage or articles of daily use, of a plurality of product types of the goods A1 handled in a store.

The plurality of second classification sections 312 correspond to the plurality of categories C₁, . . . , Cₙ, on a one-to-one basis. Moreover, each of the plurality of second classification sections 312 uses, as input data, the image, which includes the item of goods A1 and which is captured by the image capturing section 2, to identify (that is, classify) the item of goods A1 (in other words, goods information on the item of goods A1).

In FIG. 13, “[C₁], . . . , [Cₙ]” added next to “312” respectively represent categories of the item of goods A1, the second classification sections 312 corresponding to the categories. For example, the second classification section 312[C₂] is the second classification section 312 corresponding to the category C₂. Moreover, in FIG. 13, “B₁₁, . . . , B₁ₘ, . . . Bₙₘ” each represent the goods information on the item of goods A1 (wherein “m” is an integer larger than or equal to 2). For example, the second classification sections 312 corresponding to the category C₂ uses, as input data, the image, which includes the item of goods A1 and which is captured by the image capturing section 2, to identify that the goods information on the item of goods A1 is one of the pieces of goods information B₂₁, . . . , B₂ₘ. Note that a numerical value of “m” may differ for each of the plurality of second classification sections 312.

In this embodiment, the processor 31 identifies the item of goods A1 by using, not all the second classification sections 312 but, a second classification sections 312 corresponding to the category into which the item of goods A1 is classified by the first classification section 311. For example, when the first classification section 311 classifies the item of goods A1 into the category C₃, the second classification section 312 corresponding to the category C₃ in the processor 31 uses, as input data, the image, which includes the item of goods A1 and which is captured by the image capturing section 2, to identify the item of goods A1.

In the present embodiment, the first classification section 311 and the plurality of second classification sections 312 do not adopt an image from the image capturing section 2 as is but adopt a difference image. In other words, each of the plurality of second classification sections 312 classifieds an item of goods (item) A1 based on the difference image. As used herein, the term “difference image” refers to an image of a difference between an image captured by a sensing section (image capturing section 2) and an image captured by the image capturing section 2 at a second time point before the first time point. That is, the processor 31 stores an image from the image capturing section 2 in a buffer, and each time the processor 31 newly receives an image from the image capturing section 2, the processor 31 generates a difference image representing a difference from the image stored in the buffer. The image in the buffer is overwritten with the difference image thus generated, and the difference image is then used to generate an image of a difference from an image next captured by the image capturing section 2. Note that before the item of goods A1 is put in the shopping basket 1, the buffer stores a background image (an image of the placement surface 10 on which no goods A1 are put).

For example, it is assumed that in a state where a beverage A11 as an item of goods A1 is placed on the placement surface 10 as illustrated in FIG. 6A, food A12 as an item of goods A1 is put in the shopping basket 1 as illustrated in FIG. 6B. In this case, before the food A12 is put in the shopping basket 1, the processor 31 stores, in the buffer, an image as a difference image in which the beverage A11 is placed on the placement surface 10. When the food A12 is put in the shopping basket 1, the processor 31 generates a difference image representing a difference between an image at a time point at which the food A12 is put in the shopping basket 1 (the first time point) and the image (image at the second time point) stored in the buffer. In this case, the difference image is, as shown in FIG. 6C, an image in which only the food A12 is placed on the placement surface 10. The processor 31 overwrites the image in the buffer with the image (see FIG. 6B) at the time point of putting the food A12 in the shopping basket 1.

Hereafter, each time an item of goods A1 is put in the shopping basket 1, the above-described process is performed, and thereby the processor 31 receives, as input data, an image in which only the item of goods A1 newly put in the shopping basket 1 is included in the image capturing range. Thus, also when a plurality of goods A1 are put in the shopping basket 1 and the plurality of goods A1 are thus stacked on one another, the processor 31 is able to identify the plurality of goods A1 one by one.

### (3) Operation

The operation of the item identification system 300 according to the present embodiment will be described below. In the following description, a training phase will first be described. In the training phase, before the item identification system 300 is used, a learned neural network is configured by machine learning. The neural network is used by the first classification section 311 and the plurality of second classification sections 312. Next, an inference phase in which the item identification system 300 is used will be described.

### (3.1) Training Phase

Machine learning in the training phase is executed in, for example, a center for training. That is, places (e.g., stores such as convenience stores) where the item identification system 300 is used in the inference phase may be different from places where the machine learning is executed in the training phase. In the center for training, one or more processor is used to perform machine learning of the neural network used by each of the first classification section 311 and the plurality of second classification sections 312. To execute the machine learning, the weighting coefficient of each neural network is initialized. As used herein, the term “processor” can include a dedicated processor specialized for an operation in the neural network in addition to a widely used processor such as a central processing unit (CPU) and a graphics processing unit (GPU).

(3.1.1) First Classification section

First, a training data set of the first classification section 311 is used to perform machine learning of the neural network to be used in the first classification section 311. As used herein, the term “training data set” refers to a collection of plurality of pieces of training data, where a combination of a training image (hereinafter simply referred to as “training image”) input to an input layer of the neural network and teaching data corresponding to the training image is defined as one piece of training data. The training image is an image including an item of goods A1. Note that a large number of training images are preferably prepared for each item of goods A1 with the location, the size, and the angle of an item of goods A1 in the image being varied.

The training data set of the first classification section 311 includes training data about all the goods (items) A1 handled by the item identification system 300. Moreover, in the training data of the first classification section 311, the teaching data is information on a category into which the item of goods A1 included in the training image is classified.

The one or more processors input training images to the input layer of the neural network to execute an operation for each of the plurality of pieces of training data. The one or more processors use output values of a plurality of neurons of an output layer of the neural network and teaching data to execute a backpropagation (error backward propagation method) process. Here, each of the plurality of neurons of the output layer corresponds to an associated one of the plurality of categories C₁, . . . , Cₙ. In the backpropagation process, the one or more processors update the weighting coefficient of the neural network such that the output value of a neuron which is included in the plurality of neurons of the output layer and which corresponds to the teaching data is maximized.

The one or more processors execute the backpropagation process on all the pieces of training data to optimize the weighting coefficient of the neural network used in the first classification section 311. Thus, learning of the neural network used in the first classification section 311 is completed.

(3.1.2) Second Classification section

Next, for each of the plurality of second classification sections 312, a training data set of the second classification section 312 is used to perform machine learning of a neural network to be used in the second classification section 312. The training data set of the second classification section 312 includes pieces of training data about all goods A1 in categories to which the second classification sections 312 correspond, all the goods A1 being included in all the goods (items) A1 handled in the item identification system 300. For example, the training data set of the second classification section 312 corresponding to the category C₁ includes pieces of training data about all the goods A1 classified into the category C₁. Moreover, in the training data of the second classification section 312, the teaching data is goods information (item information) on the item of goods A1 included in the training image is classified.

The one or more processors input training images to the input layer of the neural network to execute an operation for each of the plurality of pieces of training data. The one or more processors use output values of a plurality of neurons of an output layer of the neural network and teaching data to execute a backpropagation process. Here, each of the plurality of neurons of the output layer corresponds to an associated one of the pieces of goods information on the plurality of goods A1 classified into the category to which the second classification section 312 corresponds. In the backpropagation process, the one or more processors update the weighting coefficient of the neural network such that the output value of a neuron which is included in the plurality of neurons of the output layer and which corresponds to the teaching data is maximized.

The one or more processors execute the backpropagation process on all the pieces of training data to optimize the weighting coefficient of the neural network used in the second classification section 312. Thus, learning of the neural network used in the second classification section 312 is completed. Hereafter, the one or more processors execute the above-described process on all the second classification sections 312. Thus, learning of the neural network used in each of all the second classification sections 312 is completed.

### (3.2) Inference Phase

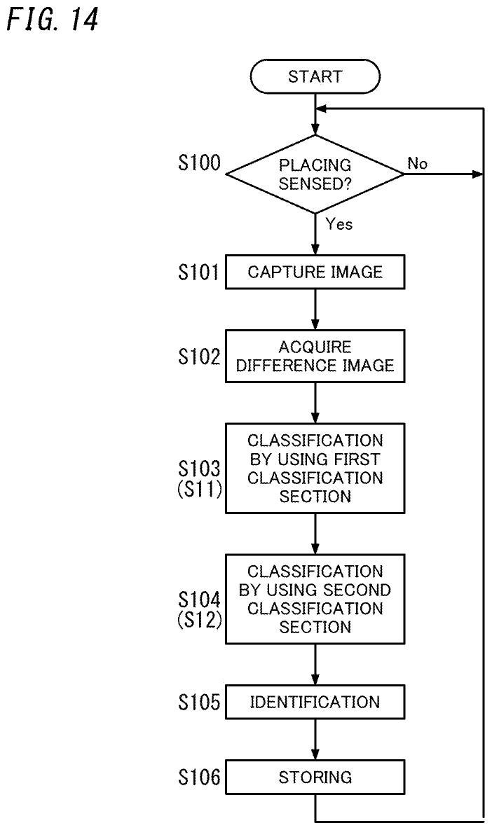

Next, operation in an inference phase of the item identification system 300 of the present embodiment will be described with reference to FIG. 14. First, a customer holds the pair of grips 12 of the shopping basket 1 stacked in the basket area with a hand, thereby moving the pair of grips 12 from the second location to the first location. Thus, the processor 31 determines, based on the sensed result by a sensor 34, that the pair of grips 12 is in the first location, the processor 31 activates the image capturing section 2.

Thereafter, the customer puts an item of goods A1, which the customer wishes to purchase, in the shopping basket 1 while the customer moves in the store. When the processor 31 senses, by using the sensing section (image capturing section 2), that the item of goods A1 is put in the shopping basket 1 (that is, the item of goods A1 is placed on the placement surface 10) (S100: Yes), the processor 31 causes the image capturing section 2 to capture an image of the item of goods A1 (S101). Thus, the processor 31 acquires an image of the item of goods A1 placed on the placement surface 10 at a time point (first time point) at which the item of goods A1 is put in the shopping basket 1.

Thereafter, the processor 31 generates a difference image between the image acquired in step S101 and an image (image at the second time point) stored in the buffer before step S101 to acquire a difference image (S102).

The processor 31 inputs the difference image as input data to the first classification section 311 to classify an item of goods A1 included in the difference image into one category of the plurality of categories C₁, . . . , Cₙ, (S103). Next, the processor 31 selects the second classification section 312 corresponding to the category into which the item of goods A1 is classified by the first classification section 311. Then, the processor 31 inputs the difference image as input data to the second classification section 312 to further classify the item of goods A1 included in the difference image (S104). In the present embodiment, classification of the item of goods A1 by the second classification section 312 corresponds to identification of the item of goods A1. Thus, the processor 31 identifies the item of goods A1 and acquires item information on the item of goods A1 identified (S105).

That is, the processor 31 acquires item information on the item of goods A1 put in the shopping basket 1 in step S100. Then, the processor 31 stores the item information thus acquired on the item of goods A1 in a storage section 32 (S106). In this way, the item identification system 300 identifies the item of goods A1 put in the shopping basket 1 based on information regarding the item of goods A1 at an input timing.

Hereafter, until the customer puts all the goods A1 that the customer wishes to purchase in the shopping basket 1, and the customer disposes the shopping basket 1 on a counter desk 53, that is, until the processor 31 determines that the pair of grips 12 is in the second location, the shopping basket 1 repeats a process from steps S100 to S106. When the processor 31 determines that the pair of grips 12 is in the second location, the processor 31 stops the image capturing section 2. Subsequent operations are common with those in the first embodiment, and the description thereof is thus omitted.

Here, when the performance, a time required for the training, the cost required for the training, and the like of the one or more processors used in the training phase are taken into consideration, the number of goods (items) A1 identifiable by one classifier (e.g., neural network) is limited. In contrast, the present embodiment adopts the first classification section 311 and the plurality of second classification sections 312 to identify an item of goods A1 in a plurality of stages. Thus, in the present embodiment, it is possible to reduce the number of goods A1 as identification targets of one classifier.

For example, it is assumed that there are 1000 types of goods A1 as identification targets. In this case, in the present embodiment, for example, the first classification section 311 enables the 1000 types of goods A1 to be classified into five categories. In this case, each of the plurality of second classification sections 312 corresponding to an associated one of the five categories includes at least a classifier whose identification targets are about 200 types of goods A1. In this case, the process load of each of the first classification section 311 and the plurality of second classification sections 312 is lower than that in the case where the 1000 types of goods A1 are identified by one classifier.

Thus, in the present embodiment, a process load of the classifier of each of the first classification section 311 and the second classification section 312 is lower than that in a case where one classifier performs the identification process of the item of goods A1 that belongs to all the categories C₁, . . . , Cₙ. As a result, the present embodiment has the advantage that even when the number of types of the goods A1 as identification targets increases, a required time for identification of the goods A1 is less likely to be increased because the process load of each of the first classification section 311 and the plurality of second classification sections 312 is less likely to be increased.

### (4) Variations

The above-described embodiment is a mere example of various embodiments of the present disclosure. The above-described embodiment may be modified in various ways depending on design and the like as long as the object of the present disclosure can be achieved. Moreover, a function similar to the function of the item information identification system 300 may be realized by an item information identification method, a computer program, a storage medium in which the program is recorded, or the like. Moreover, functions similar to those of the shopping assistance system 200 may be realized by a shopping assistance method, a computer program, a storage medium in which the program is recorded, or the like.

A shopping assistance method of one aspect includes: identifying each of one or more goods (items) A1 by an item identification method including a first step S11 (corresponding to step S103 of FIG. 14) and a second step S12 (corresponding to step S104 of FIG. 14); and performing a sales process of the one or more goods A1 each identified by the item identification method. The first step S11 is a step of classifying each of the one or more goods A1 into one or more categories of a plurality of categories C₁, . . . , Cₙ, based on a corresponding one of respective pieces of information on the one or more goods A1 placed in a shopping basket (carrier) 1. The second step S12 is a step of classifying, in addition to the first step S11, each of the one or more goods A1 classified into the one or more categories, by using a machine-learned classifier, based on an image obtained by capturing an image of each of the one or more goods A1.

An item identification method of one aspect is an item identification method for identifying each of one or more goods (items) A1 placed in a shopping basket (carrier) 1, the item identification method including: a first step S11; and a second step S12. The first step S11 is a step of classifying each of the one or more goods A1 into one or more categories of a plurality of categories C₁, . . . , Cₙ, based on a corresponding one of respective pieces of information on the one or more goods A1 placed in a shopping basket 1. The second step S12 is a step of classifying, in addition to the first step S11, each of the one or more goods A1 classified into the one or more categories, by using a machine-learned classifier, based on an image obtained by capturing an image of each of the one or more goods A1.

A non-transitory storage medium of one aspect stores a program for causing one or more processors to execute the above-described item identification method.

Variations of the above-described embodiment will be described below. Various variations described below may be combined as appropriate.

### (4.1) First Variation

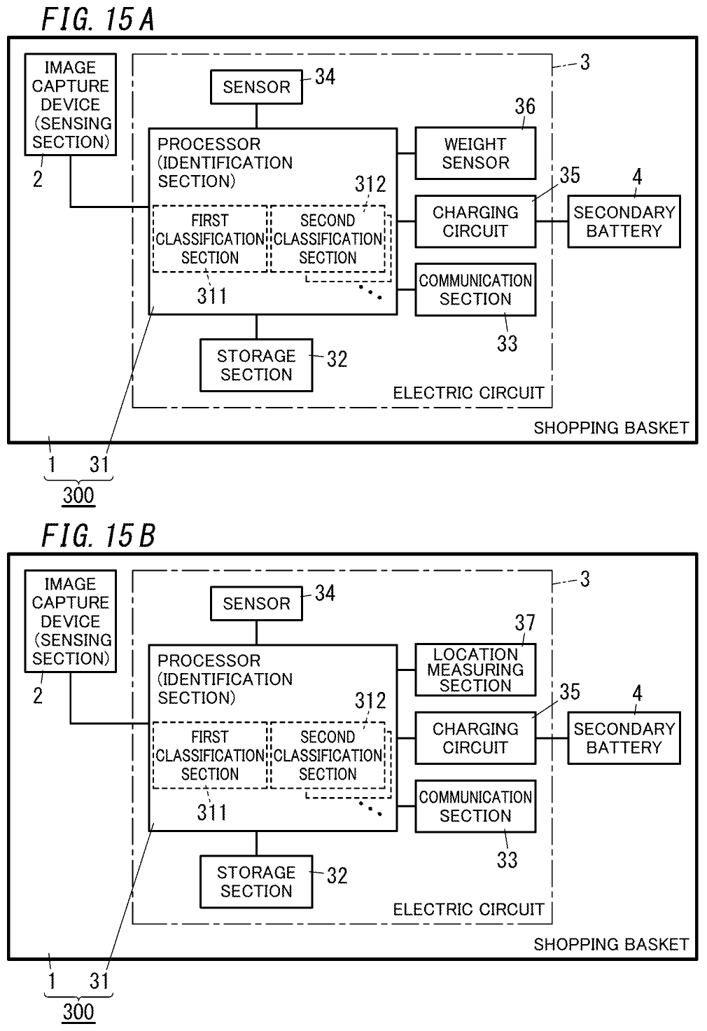

An item identification system 300 of a first variation is different from the item identification system 300 of above-described embodiment in that an electric circuit 3 includes a weight sensor 36 as illustrated in FIG. 15A. The weight sensor 36 is, for example, a pressure sensor sheet and is provided to a placement surface 10 of a shopping basket 1. The weight sensor 36 is configured to measure the weight (mass) of each of one or more goods A1 placed on the placement surface 10. In the present variation, the weight of an item of goods A1 corresponds to a difference between a value measured by the weight sensor 36 before the item of goods A1 is placed and a value measured by the weight sensor 36 at a time point at which the item of goods A1 is placed.

The present variation is different from the item identification system 300 of above-described embodiment in that a first classification section 311 classifies each of the one or more goods A1 into one or more categories of a plurality of categories C₁, . . . , Cₙ, based on the weight of a corresponding one of the one or more goods A1 measured by the weight sensor 36. That is, in the present variation, information which is used by the first classification section 311 to classify an item of goods (item) A1 and which relates to the item of goods A1 includes weight information of the item of goods A1.

In the present variation, each of the plurality of categories C₁, . . . , Cₙ, corresponds to an associated one of weight zones of goods A1. For example, goods A1 each having a weight less than 10 g belong to the category C₁, goods A1 each having a weight more than or equal to 10 g and less than 50 g belong to the category C₂, and goods A1 each having a weight more than or equal to 50 g and less than 100 g belong to the category C₃. In the present variation, the first classification section 311 at least specifies, simply based on the weight of each of the one or more goods A1 measured by the weight sensor 36, a weight zone of the plurality of weight zones into which a corresponding one of the one or more goods A1 is classified. Thus, in the present variation, the first classification section 311 does not require a machine-learned classifier such as a learned neural network.

### (4.2) Second Variation

An item identification system 300 of a second variation is different from the item identification system 300 of above-described embodiment in that an electric circuit 3 includes a location measuring section 37 as illustrated in FIG. 15B. The location measuring section 37 performs wireless communication with a transmitter installed in a store based on a communication schema such as Bluetooth Low Energy (BLE: registered trademark) or Wi-Fi (registered trademark) to measure the location of a shopping basket (carrier) 1 in the store. Here, the location measuring section 37 measures the location of the shopping basket 1, and the location of the shopping basket 1 at a time point at which an item of goods (item) A1 is put in the shopping basket 1 substantially corresponds to the location of the item of goods A1. That is, it can be said that the location measuring section 37 measures the location of the item of goods A1 at a time point when the item of goods A1 is placed in the shopping basket 1.

The present variation is different from the item identification system 300 of above-described embodiment in that a first classification section 311 classifies each of the one or more goods A1 into one or more categories of a plurality of categories C₁, . . . , Cₙ, based on the location of a corresponding one of the one or more goods A1 measured by the location measuring section 37. That is, in the present variation, information which is used by the first classification section 311 to classify an item of goods (item) A1 and which relates to the item of goods A1 includes location information of the item of goods A1 at the time point of putting the item of goods A1 in the shopping basket 1.

In the present variation, the plurality of categories C₁, . . . , Cₙ, correspond to display racks on which goods A1 are displayed in a store. For example, goods A1 displayed on a first display rack belong to the category C₁, goods A1 displayed on a second display rack belong to the category C₂, and goods A1 displayed on a third display rack belong to the category C₃. In the present variation, the first classification section 311 at least specifies, simply based on the location of each of the one or more goods A1 measured by the location measuring section 37, a display lack of a plurality of display racks into which a corresponding one of the one or more goods A1 is classified. Thus, in the present variation, the first classification section 311 does not require a machine-learned classifier such as a learned neural network.

### (4.3) Third Variation

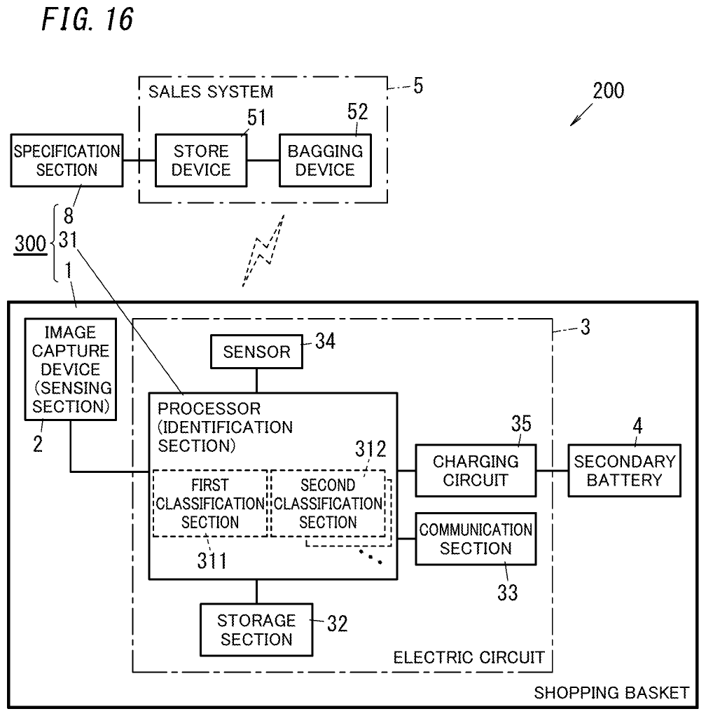

An item identification system 300 of a third variation is different from the item identification system 300 of above-described embodiment in that a specification section 8 is disposed as illustrated in FIG. 16. The specification section 8 is, for example, a reader provided to a counter desk 53 and is configured to read electronic tags attached to goods (items) A1. The electronic tag is preferably compatible with a communication standard such as radio frequency identification (RFID) or the Infrared Data Association (IrDA). The specification section 8 reads the electronic tag attached to each of the one or more goods A1 when a shopping basket (carrier) 1 is placed on the counter desk 53, thereby acquiring respective pieces of goods information on the one or more goods A1. That is, the specification section 8 specifies each of the one or more goods A1 based on the information (here, information included in the electronic tag) associated with a corresponding one of the one or more goods A1.

The present variation provides the advantage that even if an item of goods A1 difficult to be identified by a processor (identification section) 31 is present, such an item of goods A1 can be specified (identified) by the specification section 8. That is, electronic tags do not have to be provided to all the goods A1 handled in the item identification system 300 but are provided at least to one or more goods A1 which are not easily identified by the processor 31. Specifically, the electronic tags are attached at least to one or more goods A1 such as boxed lunches, and the like which are not easily identified based on only an image captured by the image capturing section 2.

### (4.4) Fourth Variation

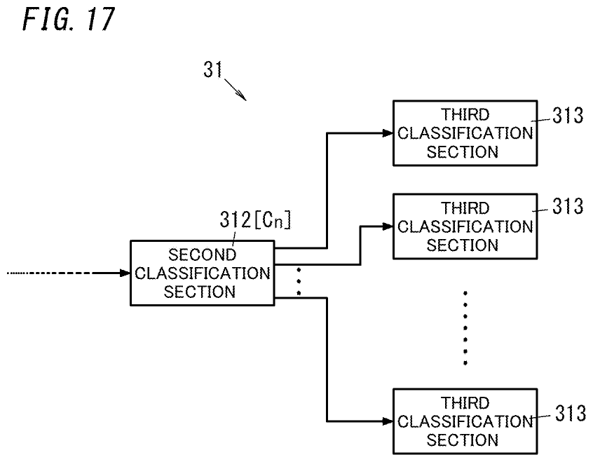

An item identification system 300 of a fourth variation different from the item identification system 300 of above-described embodiment in that a processor (identification section) 31 further includes a plurality of third classification sections 313 as illustrated in FIG. 17. In the example shown in FIG. 17, a plurality of third classification sections 313 are provided for the second classification section 312 corresponding to the category Cₙ. A plurality of third classification sections 313 may be provided for each of the plurality of second classification sections 312. In this case, the number of plurality of third classification sections 313 may differ for each of the plurality of second classification sections 312.

Each of the plurality of third classification sections 313 further performs classification of each of the one or more goods (items) A1 classified by the second classification section 312, by using, for example, a machine-learned classifier based on an image of each of the one or more goods A1 captured by the image capturing section 2. That is, in the present variation, the processor 31 includes a first classification section 311, the plurality of second classification sections 312, and the plurality of third classification sections 313 to perform identification of each of the one or more goods A1 in three stages.

For example, the first classification section 311 classifies an item of goods A1 into one category of the plurality of categories C₁, . . . , Cₙ, based on the shape of an item of goods A1. Next, the second classification section 312 corresponding to the category into which the item of goods A1 is classified by the first classification section 311 further classifies the item of goods A1 into one sub-category of a plurality of sub-categories based on the product types of goods A1. Then, the third classification section 313 corresponding to the sub-categories into which the item of goods A1 is classified by the second classification section 312 identifies the item of goods A1. As described above, the processor 31 may finely classify the item of goods A1 in a plurality of stages based on a plurality of features of the item of goods A1 to identify the item of goods A1.

### (4.5) Other Variations

Variations other than the first to fourth variations will be recited below. Various types of variations below are applicable accordingly in combination with the above-described embodiment and the first to fourth variations.

In the item identification system 300 in the present disclosure, the processor (identification section) 31, and the like include respective computer systems. The computer system includes a processor and memory as hardware as main components. The processor executes a program stored in the memory of each computer system, thereby realizing the function as the item identification system 300 of the present disclosure. The processor executes a program stored in the memory of each computer system, thereby realizing the function as the item identification system 300 of the present disclosure. The program may be stored in the memory of each computer system in advance, provided via telecommunications network, or provided via a non-transitory recording medium such as a computer system-readable memory card, an optical disc, or a hard disk drive storing the program. The processor of the computer system includes one or a plurality of electronic circuits including semiconductor integrated circuits (IC) or large-scale integrated circuits (LSI). The integrated circuit such as IC or LSI mentioned herein may be referred to in another way, depending on the degree of the integration and includes integrated circuits called system LSI, very-large-scale integration (VLSI), or ultra-large-scale integration (VLSI). Further, a FPGA, which is programmable after fabrication of the LSI, or a logical device which allows reconfiguration of connections in LSI or reconfiguration of circuit cells in LSI may be adopted as the processor. The plurality of electronic circuits may be collected on one chip or may be distributed on a plurality of chips. The plurality of chips may be collected in one device or may be distributed in a plurality of devices. As mentioned herein, the computer system includes a microcontroller including one or more processors and one or more memories. Thus, the microcontroller is also composed of one or more electronic circuits including a semiconductor integrated circuit or a large-scale integrated circuit.

In the above-described embodiment, the first classification section 311 classifies the item of goods (item) A1 into one category of the plurality of categories C₁, . . . , Cₙ, but may classify the item of goods A1 into a plurality of categories. For example, the processor 31 may determine, in accordance with the degree of inference provability of the first classification section 311, whether one second classification section 312 or the plurality of second classification sections 312 are used. As used herein, the term “inference provability” corresponds the maximum value of probability that the item of goods A1 is assumed to belong to one category of the plurality of categories C₁, . . . , Cₙ. For example, it is assumed that the number of categories is three (i.e., a first category, a second category, and a third category), and the probability that the item of goods A1 belongs to the first category is 5%, the probability that the item of goods A1 belongs to the second category is 85%, and the probability that the item of goods A1 belongs to the third category is 10%. In this case, inference provability is 85%.

For example, when the inference provability in the first classification section 311 is higher than or equal to 90%, the processor 31 identifies the item of goods A1 by using one second classification section 312. Alternatively, for example, when the inference provability in the first classification section 311 is about 30%, the processor 31 identifies the item of goods A1 by using two or more second classification sections 312 corresponding to two or more categories to which the item of goods A1 is assumed to belong and which have top two or more highest probabilities. The processor 31 adopts, among identification results by two or more second classification sections 312, an identification result by the second classification section 312 with the highest probability.

In the above-described embodiment, the neural network used in each of the first classification section 311 and the plurality of second classification sections 312 may be retrained when, for example, a new item of goods (item) A1 is added. For example, a learned model generated by the retraining (that is, a collection of weight coefficients used in the neural network) is uploaded to a server. The processor (identification section) 31 of the shopping basket (carrier) 1 communicates with the server to download the learned model and updates the neural network used in each of the first classification section 311 and the plurality of second classification sections 312.

In the above-described embodiment, the processor (identification section) 31 may further include a classifier configured to identify the number of goods (items) A1 put in the shopping basket (carrier) 1. In this aspect, for example, when a plurality of goods A1 are put in the shopping basket 1 at a time, it is possible to identify inputting of the plurality of goods A1 by using a classifier based on the difference image. When the inputting of the plurality of goods A1 is identified, the processor 31 reproduces a voice message such as “please put the goods in the shopping basket one by one again”, thereby prompting a customer to put the goods A1 one by one once again. The classifier can be generated by, for example, performing machine learning by using a training data set in which an image including one or more goods A1 is a training image and the number of goods A1 in the training image is teaching data.

In the above-described embodiment, the projection 122 protruding from the handle portion 121 of the grip 12 has the image capturing section 2, but this should not be construed as limiting. For example, the handle portion 121 of the grip 12 may have the image capturing section 2.

In the above-described embodiment, the image capturing section 2 is provided to the shopping basket (carrier) 1, but this should not be construed as limiting. For example, the image capturing section 2 may be disposed in a place, such as a ceiling or wall of a store, other than the shopping basket 1. In this aspect, the image capturing section 2 is configured to transmit and receive information to and from the processor (identification section) 31 via the communication section 33 by wireless communication. In this aspect, the processor 31 at least cuts, for example, an area including an image of an item of goods A1 out of an image captured by the image capturing section 2 and performs a normalization process for normalizing the area to an appropriate size to obtain a processed image as input data. Note that the normalization process may be performed by, for example, the image capturing section 2, other than the processor 31.

In the above-described embodiment, the arch 54 and the image capture device 55 are provided to the counter desk 53, but this should not be construed as limiting. For example, the counter desk 53 does not have to be provided with the arch 54 or the image capture device 55. In this case, the sales system 5 does not execute a process of identifying an item of goods A1. That is, in the above-described embodiment, the process of identifying the item of goods A1 may be completed in the shopping basket 1.

In the above-described embodiment, each of the first classification section 311 and the plurality of second classification section 312 is provided to the shopping basket (carrier) 1, but this should not be construed as limiting. For example, the first classification section 311 may be provided to the shopping basket 1, and the plurality of second classification sections 312 may be provided to the store device 51. Moreover, when a plurality of store devices 51 are installed in a store, the plurality of second classification sections 312 may be distributed to the plurality of store devices 51. In this aspect, of the plurality of store devices 51, a store device 51 including a second classification section 312 corresponding to a category into which the item of goods A1 is classified by the first classification section 311 at least transmits the classification result by the second classification section 312 to the store device 51 that performs checkout processing.

In the above-described embodiment, the item identification system 300 is used to identify each of one or more goods (items) A1 placed in the shopping basket (carrier) 1, but the application of the item identification system 300 is not limited to this example. For example, the item identification system 300 may be used to identify each of one or more items A1 picked up in a distribution warehouse to be placed in a basket (carrier) 1. Alternatively, the item identification system 300 may be used to identify each of one or more items A1 picked up in a factory to be placed in a carrier (for example, a basket or a tray) 1.

### (Summary)

As described above, an item information acquisition system (100) of a first aspect includes a carrier (1, 1A) and an acquirer (31). The carrier (1, 1A) includes a placement section (11, 11A), a projection (12, 12C), and an image capturing section (2). The placement section (11, 11A) includes a placement surface (10, 10A) on which an item (A1) as carriage targets are to be placed. The projection (12, 12C) protrudes from the placement section (11, 11A) in a direction transverse to the placement surface (10, 10A). The image capturing section (2) is held by the projection (12, 12C) and has an image capturing range corresponding to at least the placement surface (10, 10A). The image capturing section (2) is disposed spaced away from an entire perimeter of a peripheral edge (111, 111A) of the placement section (11, 11A) when viewed in a direction orthogonal to the placement surface (10, 10A). The acquirer (31) is configured to identify, based on an image captured by the image capturing section (2), the item (A1) placed on the placement surface (10, 10A) and acquire item information on the item (A1).

This aspect provides the advantage that the item (A1) is easily identified based on the image captured by the image capturing section (2).

In an item information acquisition system (100) of a second aspect referring to the first aspect, the projection (12) is one of one or more grips (12, 12A). The one or more grips (12, 12A) are provided to the placement section (11) and are gripped when the carrier (1) is carried.

According to this aspect, it is possible to use one of the one or more grips (12, 12A), which the carrier (1) currently has, as the projection (12) in which the image capturing section (2) is installed. Thus, this aspect provides the advantage that the projection does not have to be provided.

In an item information acquisition system (100) of a third aspect referring to the second aspect, the one or more grips include only one grip (12A).

This aspect enables a higher location of the image capturing section (2) during carrying of the carrier (1) than that in a case where a customer carries the carrier (1) by two or more grips (12). Thus, this aspect provides the advantage that the image capturing range is easily extended.

An item information acquisition system (100) of a fourth aspect referring to any one of the first to third aspects further includes a sensing section (image capturing section (2)). The sensing section is configured to sense placing of the item (A1) on the placement surface (10, 10A). When the sensing section senses the placing of the item (A1) on the placement surface (10, 10A), the image capturing section (2) captures an image.

This aspect provides the advantage that an image in which the item (A1) is captured is easily specified as compared to a case where the image capturing section (2) captures an image constantly regardless of the presence or absence of the item (A1).

In an item information acquisition system (100) of a fifth aspect referring to the fourth aspect, the acquirer (31) is configured to identify the item (A1) placed on the placement surface (10, 10A) based on a difference image. The difference image is an image corresponding to a difference between an image captured by the image capturing section (2) when sensing is performed by the sensing section and an image captured by the image capturing section (2) when before the sensing, sensing is performed by the sensing section.

This aspect provides the advantage that even when a plurality of items (A1) are disposed to be stacked on each other on the placement surface (10, 10A), each of the plurality of items (A1) is easily identified.

In an item information acquisition system (100) of a sixth aspect referring to any one of the first to fifth aspects, the acquirer (31) is configured to notify an error or execute a process of identifying the item (A1) again when the acquirer (31) fails to identify the item (A1).

This aspect provides the advantage that prompting a user to execute the process of identifying the item (A1) again or repeating the process enable accuracy of identification of the item (A1) to be increased.

In an item information acquisition system (100) of a seventh aspect referring to the second aspect, the one or more grips (12, 12A) are configured to be movable between a first location and a second location, the first location corresponding to a location in a case of carrying the carrier (1), the second location corresponding to a location in a case of not carrying the carrier (1). When the one or more grips (12, 12A) are in the first location, the image capturing section (2) is available to capture an image, and when the one or more grips (12, 12A) are in the second location, the image capturing section (2) is unavailable to capture an image.

This aspect provides the advantage that power consumption can be reduced because in a state where the carrier (1) is not used, the image capturing section (2) does not operate.

In an item information acquisition system (100) of an eighth aspect referring to any one of the first to seventh aspects, the carrier (1) further includes a cooperation device (7, 7A) which cooperates with a terminal (6, 6A) which is portable. The terminal (6, 6A) includes a storage section (60, 60A) which stores at least user information of a user of the terminal (6, 6A). The acquirer (31) refers to the user information.

This aspect provides the advantage that when the carrier (1) is used, it is possible to provide a service according to a user of the terminal (6, 6A) to the user.

In an item information acquisition system (100) of a ninth aspect referring to the eighth aspect, the terminal (6, 6A) is configured to cooperate with an electric appliance to acquire apparatus information which the electric appliance has, and then store the apparatus information in the storage section (60, 60A). The acquirer (31) refers to the apparatus information.

This aspect provides the advantage that it is possible to provide, to a user who carries the terminal (6, 6A), a service according to the apparatus information acquired from the electric appliance.

A shopping assistance system (200) of a tenth aspect includes the item information acquisition system (100) of any one of the first to ninth aspects and a sales system (5). The sales system (5) is a system configured to perform a sales process of the items (A1) placed on the placement surface (10, 10A).

This aspect provides the advantage that the item (A1) is easily identified based on the image captured by the image capturing section (2).

A shopping assistance system (200) of an eleventh aspect referring to the tenth aspect further includes a counter desk (53) on which the carrier (1) is to be disposed to cause the sales system (5) to perform a sales process. The counter desk (53) includes an image capture device (55). The image capture device (55) has an image capturing range corresponding to the placement surface (10) of the carrier (1) disposed on the counter desk (53). The sales system (5) is configured to identify, based on an image captured by the image capture device (55), the item (A1) placed on the placement surface (10).

This aspect provides the advantage that identifying the item (A1) based on both an image capturing result by the image capturing section (2) and an image capturing result by the image capture device (55), which enables accuracy of identification of the item (A1) to be improved.

A shopping assistance method of a twelfth aspect is a shopping assistance method which adopts a carrier (1, 1A). The carrier (1, 1A) includes a placement section (11, 11A), a projection (12, 12C), and an image capturing section (2). The placement section (11, 11A) includes a placement surface (10, 10A) on which an item (A1) as carriage targets are to be placed. The projection (12, 12C) protrudes from the placement section (11, 11A) in a direction transverse to the placement surface (10, 10A). The image capturing section (2) is held by the projection (12, 12C) and has an image capturing range corresponding to at least the placement surface (10, 10A). The image capturing section (2) is disposed spaced away from an entire perimeter of a peripheral edge (111, 111A) of the placement section (11, 11A) when viewed in a direction orthogonal to the placement surface (10, 10A). The shopping assistance method includes capturing an image of the placement surface (10, 10A) on which the item (A1) is placed by the image capturing section (2). The shopping assistance method further includes identifying, based on the image captured by the image capturing section (2), the item (A1) placed on the placement surface (10, 10A) and acquiring item information on the item (A1). The shopping assistance method further includes performing a sales process of the item (A1) placed on the placement surface (10, 10A) based on the item information.

This aspect provides the advantage that the item (A1) is easily identified based on the image captured by the image capturing section (2).

The carrier (1, 1A) of the thirteenth aspect is adopted in the item information acquisition system (100) of any one of the first to ninth aspects. The carrier (1, 1A) including a placement section (11, 11A) including the placement surface (10, 10A) on which the item (A1) as the carriage target is to be placed, the projection (12, 12C) protruding from the placement section (11, 11A) in the direction transverse to the placement surface (10, 10A), and the image capturing section (2) held by the projection (12, 12C) and having the image capturing range corresponding to at least the placement surface (10, 10A). The image capturing section (11, 11A) being disposed spaced away from the entire perimeter of the peripheral edge (111, 111A) of the placement section (11, 11A) when viewed in the direction orthogonal to the placement surface (10, 10A).

This aspect provides the advantage that the item (A1) is easily identified based on the image captured by the image capturing section (2).

The configurations of the second to ninth aspects are not essential configurations for the item information acquisition system (100) and may accordingly be omitted. Moreover, the configuration of the eleventh aspect is not an essential configuration for the shopping assistance system (200) and may accordingly be omitted.

Moreover, as described above, an item identification system (300) of a fourteenth aspect includes an image capturing section (2) and an identification section (31). The image capturing section (2) captures an image of an item (A1) placed in a carrier (1).The identification section (31) is configured to identify the item (A1). The identification section (31) includes a first classification section (311) and a plurality of second classification section (312). The first classification section (311) is configured to classify the item (A1) into one or more categories of a plurality of categories (C₁, . . . , Cₙ), based on information on the item (A1). Each of the plurality of second classification sections (312) is provided to a corresponding one of the plurality of categories (C₁, . . . , Cₙ). Each of the plurality of second classification sections (312) classifies the item (A1) classified into the one or more categories, by using a machine-learned classifier, based on an image of the item (A1) captured by the image capturing section (2).

This aspect provides the advantage that even when the number of types of items (A1) as identification targets increases, a required time for identification of each of the items (A1) is less likely to be increased.

In an item identification system (300) of a fifteenth aspect referring to the fourteenth aspect, the information the item (A1) includes an image information of the item (A1) captured by the image capturing section (2).

This aspect provides the advantage that a means other than the image capturing section (2) does not have to be prepared to acquire the information on the item (A1).

In an item identification system (300) of a sixteenth aspect referring to the fourteenth or fifteenth aspect, the information on the item (A1) include weight information of the items (A1).

This aspect provides the advantage that the item (A1) is easily classified into one or more categories as compared to a case where image information on the item (A1) captured by the image capturing section (2) is used.

In an item identification system (300) of a seventeenth aspect referring to any one of the fourteenth to sixteenth aspects, the information on each of the one or more items (A1) includes location information of the item (A1) when the item (A1) is placed in the carrier (1).

This aspect provides the advantage that the item (A1) is easily classified into one or more categories as compared to a case where image information on the item (A1) captured by the image capturing section (2) is used.

An item identification system (300) of an eighteenth aspect referring to any one of the fourteenth to seventeenth aspects further includes a specification section (8) configured to specify the item (A1) based on information associated with the item (A1).

In this aspect, even if one or more items (A1) that cannot be identified by the identification section (31) are present, it is possible to specify each of the one or more items (A1).

In an item identification system (300) of a nineteenth aspect referring to any one of the fourteenth to eighteenth aspects, the image capturing section (2) is provided to the carrier (1) and has an image capturing range corresponding to at least the placement surface (10) on which the item (A1) is to be placed.

This aspect provides an advantage that an image captured by the image capturing section (2) is more likely to include the entirety of the item (A1) and thus it is easy to identify the item (A1).

An item identification system (300) of an twentieth aspect referring to any one of the fourteenth to nineteenth aspects further includes a sensing section (image capturing section (2)). The sensing section is configured to sense placing of the item (A1) in the carrier (1). When the sensing section senses the placing of the item (A1) on the carrier (1), the image capturing section (2) captures an image.

This aspect provides the advantage that based on an image in which the item (A1) is captured, the item (A1) is easily identified as compared to a case where the image capturing section (2) captures an image constantly regardless of the presence or absence of the item (A1)

In an item identification system (300) of a twenty-first aspect referring to the twentieth aspect, each of the plurality of second classification section (312) is configured to classify the item (A1) based on a difference image. The difference image is an image of a difference between an image captured by a sensing section and an image captured by the image capturing section (2) at a second time point before the first time point.

This aspect provides the advantage that even when a plurality of items (A1) are placed to be stacked on each other on the carrier (1), each of the plurality of items (A1) is easily identified.

A shopping assistance system (200) of a twenty-second aspect includes the item identification system (300) of any one of the fourteenth to twenty-first aspects and a sales system (5). The sales system (5) is a system configured to perform a sales process of the item (A1).

This aspect provides the advantage that even when the number of types of items (A1) as identification targets increases, a required time for identification of each of the items (A1) is less likely to be increased.

A shopping assistance method of a twenty-third aspect includes: identifying an item (A1) by an item identification method including a first step (S11) and a second step (S12); and performing a sales process of the item (A1) each identified by the item identification method. The first step (S11) is a step of classifying the item (A1) into one or more categories of a plurality of categories (C₁, . . . , Cₙ) based on a corresponding one of respective pieces of information on the item (A1) placed in a carrier (1). The second step (S12) is a step of classifying, in addition to the first step (S11), the item (A1) classified into the one or more categories by using a machine-learned classifier based on an image obtained by imaging the item (A1).

This aspect provides the advantage that even when the number of types of items (A1) as identification targets increases, a required time for identification of each of the items (A1) is less likely to be increased.

An item identification method of twenty-fourth aspect is an item identification method for identifying an item (A1) placed in a carrier 1, the item identification method including: a first step (S11); and a second step (S12). The first step (S11) is a step of classifying the item (A1) into one or more categories of a plurality of categories (C₁, . . . , Cₙ) based on a corresponding one of respective pieces of information on the item (A1) placed in a carrier 1. The second step (S12) is a step of classifying, in addition to the first step (S11), the item (A1) classified into the one or more categories by using a machine-learned classifier based on an image obtained by imaging the item (A1).

This aspect provides the advantage that even when the number of types of items (A1) as identification targets increases, a required time for identification of each of the items (A1) is less likely to be increased.

A non-transitory storage medium of a twenty-fifth aspect stores a program for causing one or more processors to execute the item identification method of the eleventh aspect.

This aspect provides the advantage that even when the number of types of items (A1) as identification targets increases, a required time for identification of each of the items (A1) is less likely to be increased.

The configurations of the fifteenth to twenty-first aspects are not essential configurations for the item identification system (300) and may accordingly be omitted.

1. An item information acquisition system, comprising:
a carrier including
a placement section including a placement surface on which an item as a carriage target is to be placed,
a projection protruding from the placement section in a direction transverse to the placement surface, and
an image capturing section held by the projection and having an image capturing range corresponding to at least the placement surface, the image capturing section being disposed spaced away from an entire perimeter of a peripheral edge of the placement section when viewed in a direction orthogonal to the placement surface; and
an acquirer configured to
identify, based on an image captured by the image capturing section, the item placed on the placement surface and
acquire item information on the item.

2. The item information acquisition system of claim 1, wherein
the projection is one of one or more grips provided to the placement section, the one or more grips being gripped when the carrier is carried.

3. The item information acquisition system of claim 2, wherein
the one or more grips include only one grip.

4. The item information acquisition system of claim 1, further comprising a sensing section configured to sense placing of the item on the placement surface, wherein
when the sensing section senses the placing of the item on the placement surface, the image capturing section captures an image.

5. The item information acquisition system of claim 4, wherein
the acquirer is configured to identify the item placed on the placement surface based on a difference image, and
the difference image is an image corresponding to a difference between an image captured by the image capturing section when sensing is performed by the sensing section and an image captured by the image capturing section when before the sensing, sensing is performed by the sensing section.

6. The item information acquisition system of claim 1, wherein
the acquirer is configured to notify an error or execute a process of identifying the item again when the acquirer fails to identify the item.

7. The item information acquisition system of claim 2, wherein
the one or more grips are configured to be movable between a first location and a second location, the first location corresponding to a location in a case of carrying the carrier, the second location corresponding to a location in a case of not carrying the carrier, and
when the grip is in the first location, the image capturing section is available to capture an image, and when the grip is in the second location, the image capturing section is unavailable to capture an image.

8. The item information acquisition system of claim 1, wherein
the carrier further includes a cooperation device which cooperates with a terminal which is portable,
the terminal includes a storage section which stores at least user information of a user of the terminal, and
the acquirer refers to the user information.

9. The item information acquisition system of claim 8, wherein
the terminal is configured to cooperate with an electric appliance to acquire apparatus information which the electric appliance has, and then store the apparatus information in the storage section, and
the acquirer refers to the apparatus information.

10. The item information acquisition system of claim 2, further comprising a sensing section configured to sense placing of the item on the placement surface, wherein
when the sensing section senses the placing of the item on the placement surface, the image capturing section captures an image.

11. The item information acquisition system of claim 3, further comprising a sensing section configured to sense placing of the items on the placement surface, wherein
when the sensing section senses the placing of the item on the placement surface, the image capturing section captures an image.

12. The item information acquisition system of claim 2, wherein
the acquirer is configured to notify an error or execute a process of identifying the one or more items again when the acquirer fails to identify the item.

13. The item information acquisition system of claim 3, wherein
the acquirer is configured to notify an error or execute a process of identifying the item again when the acquirer fails to identify the item.

14. The item information acquisition system of claim 4, wherein
the acquirer is configured to notify an error or execute a process of identifying the item again when the acquirer fails to identify the item.

15. The item information acquisition system of claim 5, wherein
the acquirer is configured to notify an error or execute a process of identifying the item again when the acquirer fails to identify the item.

16. The item information acquisition system of claim 2, wherein
the carrier further includes a cooperation device which cooperates with a terminal which is portable,
the terminal includes a storage section which stores at least user information of a user of the terminal, and
the acquirer refers to the user information.

17. A shopping assistance system, comprising:
the item information acquisition system of claim 1; and
a sales system configured to perform a sales process of the item placed on the placement surface.

18. The shopping assistance system of claim 17, further comprising a counter desk on which the carrier is to be disposed to cause the sales system to perform a sales process, wherein
the counter desk includes an image capture device which has an image capturing range corresponding to the placement surface of the carrier disposed on the counter desk, and
the sales system is configured to identify, based on an image captured by the image capture device, the item placed on the placement surface.

19. A shopping assistance method which adopts a carrier including
a placement surface on which an item as a carriage target is to be placed,
a projection protruding from the placement section in a direction transverse to the placement surface, and
an image capturing section held by the projection and having an image capturing range corresponding to at least the placement surface, the image capturing section being disposed spaced away from an entire perimeter of a peripheral edge of the placement section when viewed in a direction orthogonal to the placement surface,
the shopping assistance method comprising:
capturing an image of the placement surface on which the item is placed by the image capturing section;
identifying, based on the image captured by the image capturing section, the item placed on the placement surface and acquiring item information on the item; and
performing a sales process of the item placed on the placement surface based on the item information.

20. A carrier used in the item information acquisition system of claim 1, the carrier including
a placement section including the placement surface on which the item as the carriage target is to be placed,
the projection protruding from the placement section in the direction transverse to the placement surface, and
the image capturing section held by the projection and having the image capturing range corresponding to at least the placement surface, the image capturing section being disposed spaced away from the entire perimeter of the peripheral edge of the placement section when viewed in the direction orthogonal to the placement surface.
